(19) United States
(12) Patent Application Publication
(10) Pub. No.: US 2021/0289204 A1
(43) Pub. Date: Sep. 16, 2021

(54) METHOD FOR ENCODING/DECODING IMAGE AND APPARATUS THEREFOR

(71) Applicant: Samsung Electronics Co., Ltd, Suwon-si (KR)

(72) Inventors: Yin-ji PIAO, Yongin-si (KR); Chan-yul KIM, Seognam-si (KR)

(73) Assignee: Samsung Electronics Co., Ltd., Suwon-si (KR)

(21) Appl. No.: 16/318,010

(22) PCT Filed: Jul. 13, 2017
(86) PCT No.: PCT/KR2017/007498

§ 371 Date: Jan. 15, 2019

Related U.S. Application Data
(60) Provisional application No. 62/362,160, filed on Jul. 14, 2016.

(51) Int. Cl. H04N 19/124; H04N 19/159; H04N 19/117; H04N 19/174

(52) U.S. Cl. CPC H04N 19/124; H04N 19/174; H04N 19/117; H04N 19/159

(57) ABSTRACT

According to an embodiment, an image decoding method and an image decoding apparatus capable of performing the image decoding method are provided. The image decoding method includes determining, based on image data obtained from a bitstream, a plurality of coding units included in a current slice that is one of a plurality of slices included in an image; determining a prediction method performed on a current coding unit that is one of the plurality of coding units; determining a quantization parameter of the current coding unit, based on whether the prediction method performed on the current coding unit is inter prediction or intra prediction; and decoding the image by using the determined quantization parameter. According to an embodiment, an image encoding method and an image encoding apparatus capable of performing the image encoding method involving processes opposite or similar to the image decoding method are provided.

### TECHNICAL FIELD

A method and apparatus according to an embodiment are provided to encode or decode an image by setting a quantization parameter of an intra-predicted block and an inter-predicted block.

### BACKGROUND ART

A residual sample used in a process of encoding an image may be transformed and quantized, and a reconstruction process may be performed by using a signal that has undergone a transformation and quantization process and then been inverse-transformed and inverse-quantized. A quantization parameter indicating strength of quantization and inverse quantization may be determined based on a coding unit.

### DESCRIPTION OF EMBODIMENTS

### Technical Problem

According to a transformation and quantization process, when a signal that has been transformed from a spatial domain to a frequency domain is quantized, an error may occur, and a quality of an image that is decoded based on the error may deteriorate. Also, when a lot of data is encoded to reduce the deterioration in the quality, compression efficiency of the image may be degraded.

### Solution to Problem

According to an embodiment, an image decoding method includes determining, based on image data obtained from a bitstream, a plurality of coding units included in a current slice that is one of a plurality of slices included in an image; determining a prediction method performed on a current coding unit that is one of the plurality of coding units; determining a quantization parameter of the current coding unit, based on whether the prediction method performed on the current coding unit is inter prediction or intra prediction; and decoding the image by using the determined quantization parameter.

According to an embodiment, an image decoding apparatus includes an obtainer configured to obtain image data from a bitstream; a decoder configured to determine, based on the image data, a plurality of coding units included in a current slice that is one of a plurality of slices included in an image, to determine a prediction method performed on a current coding unit that is one of the plurality of coding units, to determine a quantization parameter of the current coding unit, based on whether the prediction method performed on the current coding unit is inter prediction or intra prediction, and to decode the image by using the determined quantization parameter.

According to an embodiment, an image encoding method includes determining a plurality of coding units included in a current slice that is one of a plurality of slices included in an image; determining a prediction method performed on a current coding unit that is one of the plurality of coding units; determining a quantization parameter of the current coding unit, based on whether the prediction method performed on the current coding unit is inter prediction or intra prediction; and generating a bitstream including information about the image encoded by using the determined quantization parameter.

### Advantageous Effects of Disclosure

According to an embodiment, a quantization parameter of a coding unit on which intra prediction of a coding unit is performed is set to be greater than a quantization parameter of a coding unit on which inter prediction is performed, and therefore, an error between the coding units on which different prediction methods are performed may be decreased.

### BRIEF DESCRIPTION OF DRAWINGS

FIG. 1A is a block diagram of an image decoding apparatus capable of determining a quantization parameter of a coding unit by referring to a prediction method of the coding unit, according to an embodiment.

FIG. 1B is a block diagram of an image encoding apparatus capable of determining a quantization parameter of a coding unit by referring to a prediction method of the coding unit, according to an embodiment.

FIG. 2A is a flowchart for describing an image decoding method that may be performed by the image decoding apparatus, according to an embodiment.

FIG. 2B is a flowchart for describing an image encoding method that may be performed by the image encoding apparatus, according to an embodiment.

FIG. 3 is a diagram illustrating a relation among slices and coding units, the slices configuring an image and the coding units being included in a largest coding unit, according to an embodiment.

FIG. 4 is a flowchart of a process of determining a quantization parameter according to respective intra and inter coding units and decoding an image, according to an embodiment.

FIG. 5A is a flowchart of a method of determining a quantization parameter of an intra coding unit, according to an embodiment.

FIG. 5B is a flowchart of a process of determining a quantization parameter of a current coding unit, based on a first offset or a second offset, according to an embodiment.

FIG. 5C is a flowchart of a process of determining a quantization parameter of an intra coding unit and a quantization parameter of an inter coding unit, based on a third offset, according to an embodiment.

FIG. 6 is a flowchart of a process of determining a current quantization parameter of a coding unit by using a base quantization parameter and an offset, the base quantization parameter being determinable according to each coding unit, according to an embodiment.

FIG. 7 illustrates a flowchart of a method of determining a quantization parameter of a current coding unit, based on a size and a prediction mode of a coding unit, according to an embodiment.

FIG. 8 illustrates a flowchart of a method of performing deblocking filtering by using a quantization parameter determined based on a prediction mode of a coding unit, according to an embodiment.

FIG. 9 illustrates a process of performing deblocking filtering by using a quantization parameter determined based on a prediction mode of a coding unit, according to an embodiment.

FIG. 10 illustrates an operation of determining one or more coding units by partitioning a current coding unit, according to an embodiment.

FIG. 11 illustrates an operation of determining one or more coding units by partitioning a non-square coding unit, according to an embodiment.

FIG. 12 illustrates an operation of partitioning a coding unit, based on at least one of block shape information and partition shape information, according to an embodiment.

FIG. 13 illustrates a method of determining a predetermined coding unit from among an odd number of coding units, according to an embodiment.

FIG. 14 illustrates a processing order of a plurality of coding units determined by partitioning a current coding unit, according to an embodiment.

FIG. 15 illustrates an operation of determining that a current coding unit is partitioned into an odd number of coding units, when the coding units are not processable in a predetermined order, according to an embodiment.

FIG. 16 illustrates an operation of determining one or more coding units by partitioning a first coding unit, according to an embodiment.

FIG. 17 illustrates that partitioning methods of determining non-square second coding units by partitioning a first coding unit are restricted when the second coding units satisfy a predetermined condition, according to an embodiment.

FIG. 18 illustrates an operation of partitioning a square coding unit when partition shape information indicates not to partition the square coding unit into four square coding units, according to an embodiment.

FIG. 19 illustrates that a processing order of a plurality of coding units is variable depending on an operation of partitioning a coding unit, according to an embodiment.

FIG. 20 illustrates an operation of determining a depth of a coding unit as the shape and size of the coding unit varies when a plurality of coding units are determined by recursively partitioning the coding unit, according to an embodiment.

FIG. 21 illustrates depths of coding units and part indices (PIDs) for distinguishing the coding units, which are determinable based on the shapes and sizes of the coding units, according to an embodiment.

FIG. 22 illustrates that a plurality of coding units are determined based on a plurality of predetermined data units included in a picture, according to an embodiment.

FIG. 23 illustrates a processing block serving as a unit for determining a determination order of reference coding units included in a picture, according to an embodiment.

### BEST MODE

According to an embodiment, an image decoding method includes determining, based on image data obtained from a bitstream, a plurality of coding units included in a current slice that is one of a plurality of slices included in an image; determining a prediction method performed on a current coding unit that is one of the plurality of coding units; determining a quantization parameter of the current coding unit, based on whether the prediction method performed on the current coding unit is inter prediction or intra prediction; and decoding the image by using the determined quantization parameter.

The determining of the quantization parameter of the current coding unit may include determining whether a type of the current slice including the current coding unit is an intra slice type or an inter slice type; and when the type of the current slice is an inter slice, determining the quantization parameter of the current coding unit, based on whether the prediction method performed on the current coding unit is the inter prediction or the intra prediction.

The determining of the quantization parameter of the current coding unit may include obtaining at least one offset information from the bitstream; and determining the quantization parameter of the current coding unit, based on the at least one offset information and a quantization parameter of at least one of an intra coding unit and an inter coding unit, wherein the intra coding unit is a coding unit on which the intra prediction is to be performed and the inter coding unit is a coding unit on which the inter prediction is to be performed.

The determining of the quantization parameter of the current coding unit may include determining the quantization parameter of the intra coding unit, based on a quantization parameter of the current slice and a first offset included in the at least one offset information, wherein the quantization parameter of the intra coding unit is greater than the quantization parameter of the inter coding unit.

The quantization parameter of the inter coding unit may be equal to the quantization parameter of the current slice.

The determining of the quantization parameter of the current coding unit may include determining the quantization parameter of the intra coding unit, based on a quantization parameter of the current slice and a first offset included in the at least one offset information; and determining the quantization parameter of the inter coding unit, based on the quantization parameter of the current slice and a second offset included in the at least one offset information.

The determining of the quantization parameter of the current coding unit may include determining the quantization parameter of the intra coding unit by adding a third offset to a quantization parameter of the current slice, the third offset being included in the at least one offset information; and determining the quantization parameter of the inter coding unit by subtracting the third offset from the quantization parameter of the current slice, wherein the third offset has a value greater than 0.

The obtaining of the at least one offset information may include obtaining the at least one offset information from the bitstream with respect to at least one of a sequence parameter set (SPS), a picture parameter set (PPS), a slice header, and a largest coding unit.

The determining of the quantization parameter of the current coding unit may include determining a quantization parameter of a luma component of the current coding unit, based on whether the prediction method performed on the current coding unit is the inter prediction or the intra prediction; and determining a quantization parameter of a chroma component of the current coding unit, based on the quantization parameter of the luma component.

The determining of the quantization parameter of the current coding unit may include determining a quantization parameter of the current slice; determining a base quantization parameter of the current coding unit, based on the quantization parameter of the current slice and a difference quantization parameter obtained from the bitstream according to each of the plurality of coding units; determining an offset of the current coding unit, based on whether the prediction method performed on the current coding unit is inter prediction or intra prediction; and determining the quantization parameter of the current coding unit, based on the base quantization parameter and the offset.

The determining of the quantization parameter of the current coding unit may include, only when the current slice is determined to be a slice to be referred to in a process of performing inter prediction in the image, determining the quantization parameter of the current coding unit based on whether the prediction method performed on the current coding unit is inter prediction or intra prediction.

The determining of the quantization parameter of the current coding unit may include determining whether a size of the current coding unit is equal to or less than a preset size; and when the size of the current coding unit is equal to or less than the preset size, determining the quantization parameter of the current coding unit based on whether the prediction method performed on the current coding unit is inter prediction or intra prediction.

The determining of the quantization parameter of the current coding unit may include, when the size of the current coding unit is greater than the preset size, determining the quantization parameter of the current coding unit based on a quantization parameter of the current slice and a difference quantization parameter of the current coding unit, the difference quantization parameter being obtained from the bitstream.

The decoding of the image may include determining a reconstructed image associated with the image, based on the determined quantization parameter; performing deblocking filtering on the reconstructed image; and determining a filtered reconstructed image, based on a result of the deblocking filtering.

According to an embodiment, an image decoding apparatus includes an obtainer configured to obtain image data from a bitstream; a decoder configured to determine, based on the image data, a plurality of coding units included in a current slice that is one of a plurality of slices included in an image, to determine a prediction method performed on a current coding unit that is one of the plurality of coding units, to determine a quantization parameter of the current coding unit, based on whether the prediction method performed on the current coding unit is inter prediction or intra prediction, and to decode the image by using the determined quantization parameter.

According to an embodiment, an image encoding method includes determining a plurality of coding units included in a current slice that is one of a plurality of slices included in an image; determining a prediction method performed on a current coding unit that is one of the plurality of coding units; determining a quantization parameter of the current coding unit, based on whether the prediction method performed on the current coding unit is inter prediction or intra prediction; and generating a bitstream including information about the image encoded by using the determined quantization parameter.

### MODE OF DISCLOSURE

Advantages and features of the present disclosure and methods of accomplishing the same may be understood more readily by reference to the following detailed descriptions of embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those of ordinary skill in the art.

Hereinafter, terms that are used in the specification will be briefly described, and the present disclosure will be described in detail.

All terms used in the present disclosure are general terms that are selected in consideration of their functions in the disclosure and are currently widely used. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed descriptions of the disclosure. Thus, the terms used herein have to be defined based on the meaning of the terms together with the description throughout the specification.

Throughout the specification, a singular form may include plural forms, unless there is a particular description contrary thereto.

Throughout the specification, when a part “includes” or “comprises” an element, unless there is a particular description contrary thereto, the part may further include other elements, not excluding the other elements. The term ‘unit’, as used in the specification, means, but is not limited to, a software or hardware component, such as a Field Programmable Gate Array (FPGA) or Application Specific Integrated Circuit (ASIC), which performs certain tasks. A “unit” may advantageously be configured to reside on the addressable storage medium and configured to execute on one or more processors. Thus, a “unit” may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and “units” may be combined into fewer components and “units” or further separated into additional components and “units”.

Hereinafter, an “image” may indicate a static image such as a still image of a video or may indicate a dynamic image such as a moving picture that is the video itself.

Hereinafter, a “sample” may refer to data that is allocated to a sampling location of an image and is a processing target. For example, pixel values in an image of a spatial domain and transform coefficients of a transform domain may be samples. A unit including at least one of the samples may be defined as a block.

Hereinafter, the present disclosure will now be described more fully with reference to the accompanying drawings for one of ordinary skill in the art to be able to perform the present disclosure without any difficulty. In addition, portions irrelevant to the description of the present disclosure will be omitted in the drawings for a clear description of the present disclosure.

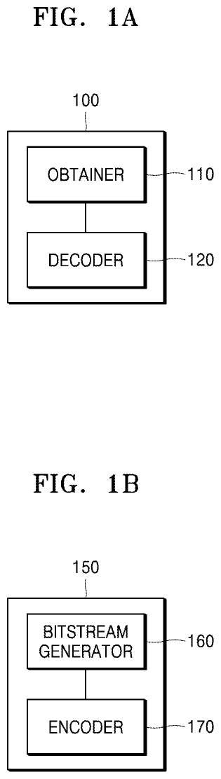

FIG. 1A is a block diagram of an image decoding apparatus 100 capable of determining a quantization parameter of a coding unit by referring to a prediction method of the coding unit, according to an embodiment.

The image decoding apparatus 100 according to an embodiment may include an obtainer 110 and a decoder 120, wherein the obtainer 110 is configured to obtain, from a bitstream, image data related to an image to be decoded, and the decoder 120 is configured to determine, based on information obtained from the bitstream, a plurality of coding units included in a current slice that is one of a plurality of slices included in the image, to determine a prediction method performed on a current coding unit that is one of the plurality of coding units, to determine a quantization parameter of the current coding unit, based on whether the prediction method performed on the current coding unit is inter prediction or intra prediction, and to decode the image by using the determined quantization parameter. Hereinafter, various embodiments of an image decoding method performed by the obtainer 110 and the decoder 120 will now be described.

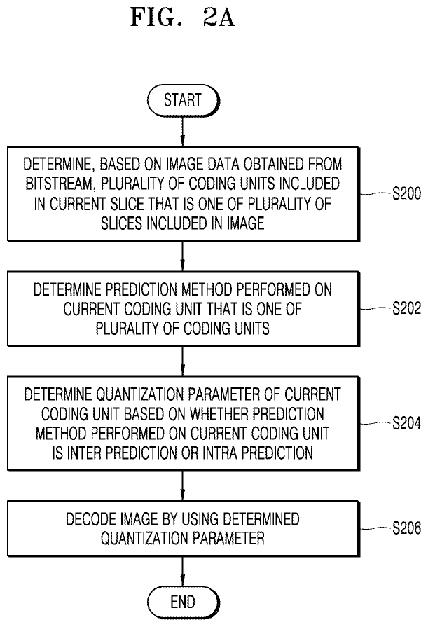

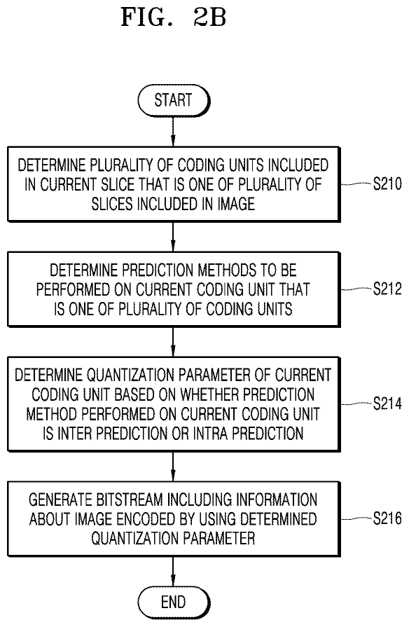

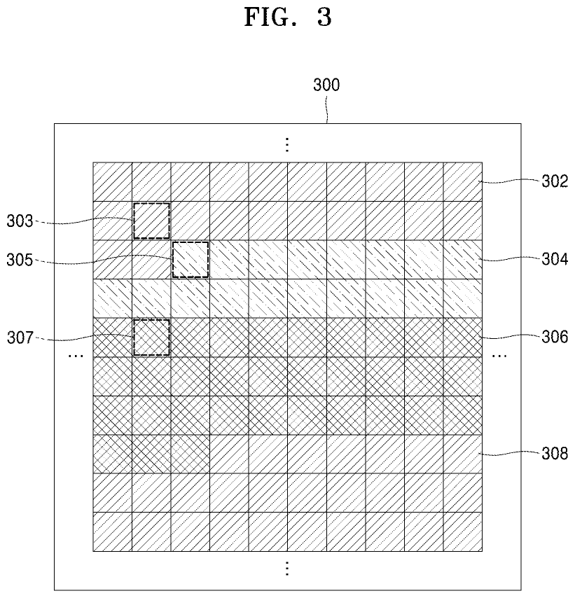

FIG. 2A is a flowchart of an image decoding method that the image decoding apparatus 100 may perform according to an embodiment.

In operation S200, the image decoding apparatus 100 according to an embodiment may determine, based on image data obtained from a bitstream, a plurality of coding units included in a current slice that is one of a plurality of slices included in an image.

According to an embodiment, the obtainer 110 of the image decoding apparatus 100 may obtain, from the bitstream, the image data related to the image to be decoded, and the decoder 120 may determine, based on the image data, the plurality of coding units included in the current slice that is one of the plurality of slices included in the image. According to an embodiment, the image may include a plurality of pictures, and each of the pictures may be partitioned into various data units. According to an embodiment, each picture may be partitioned into various data units including tiles, slices, slice segments, largest coding units, or the like. According to an embodiment, each of the tiles, the slices, and the slice segments may include an integer number of largest coding units. The largest coding units may each be recursively partitioned based on partitioning information of a coding unit, and thus each of the largest coding units may include at least one coding unit.

According to an embodiment, in operation S202, the image decoding apparatus 100 may determine a prediction method performed on a current coding unit that is one of the plurality of coding units determined in operation S200. According to an embodiment, the decoder 120 may determine prediction to be performed on each coding unit. According to an embodiment, the prediction method performed may include various prediction methods including intra prediction and inter prediction. According to an embodiment, the decoder 120 may determine a prediction method performed on a coding unit, based on prediction mode information obtained from a bitstream according to the coding unit.

According to an embodiment, the decoder 120 may determine one or more slices included in a current picture, and may determine a plurality of coding units included in each of the slices. The decoder 120 may determine, according to each of the plurality of coding units, whether a slice type of a current coding unit is an intra slice (i.e., I slice) or an inter slice (i.e., P slice or B slice).

According to an embodiment, when the current coding unit is determined to be included in the inter slice, the decoder 120 may determine that intra prediction or inter prediction is to be performed on the current coding unit. According to an embodiment, the obtainer 110 may obtain, from the bitstream, prediction mode information indicating a prediction mode to be performed on a coding unit, and the decoder 120 may determine a prediction mode to be performed on the current coding unit, based on the prediction mode information.

According to an embodiment, when the current coding unit is determined to be included in the intra slice, the decoder 120 may determine that intra prediction is to be performed on the current coding unit. According to an embodiment, when the current coding unit is determined to be included in the intra slice, the image decoding apparatus 100 may not obtain the prediction mode information from the bitstream and may determine that the current coding unit is to be predicted based on an intra prediction mode that is a predetermined prediction mode.

FIG. 3 is a diagram illustrating a relation among slices and coding units, the slices configuring an image and the coding units being included in a largest coding unit, according to an embodiment.

According to an embodiment, the image decoding apparatus 100 may determine, according to each of the slices, whether the slices configuring the image are each an intra slice (i.e., I slice) or an inter slice (i.e., P slice or B slice), based on slice type information obtained from a bitstream. Referring to FIG. 3, the obtainer 110 may determine respective slice types, based on slice type information indicating types of a plurality of slices 302, 304, 306, 308, and the like included in a current picture 300. According to an embodiment, the current picture 300 may include intra slices 302 and 308, a uni-directional inter slice 304, a bi-directional inter slice 306, or the like.

According to an embodiment, the decoder 120 may determine a prediction mode of a coding unit included in the intra slices 302 and 308. The decoder 120 according to an embodiment may determine at least one coding unit by recursively partitioning a largest coding unit (e.g., a unit 303) included in one of the intra slices 302, and may determine a prediction mode of the at least one coding unit to be an intra prediction mode.

In operation S204, the decoder 120 may determine a quantization parameter of the current coding unit based on whether the prediction method performed on the current coding unit is inter prediction or intra prediction.

According to an embodiment, the decoder 120 may determine the quantization parameter, based on whether prediction methods of respective coding units are each intra prediction or inter prediction, the prediction methods being determined in operation S202. According to an embodiment, the decoder 120 may determine a quantization parameter of an intra coding unit to be greater than a quantization parameter of an inter coding unit, wherein intra prediction is performed on the intra coding unit and inter prediction is performed on the inter coding unit. A process of determining a quantization parameter will be described in detail through various embodiments.

In operation S206, the decoder 120 may decode the image by using the quantization parameter determined in operation S204. The image decoding method using a quantization parameter may include various methods. According to an embodiment, the decoder 120 may perform an inverse quantization process on a residual signal of the image by using the quantization parameter determined in operation S204. According to an embodiment, the decoder 120 may perform deblocking filtering based on the quantization parameter determined in operation S204.

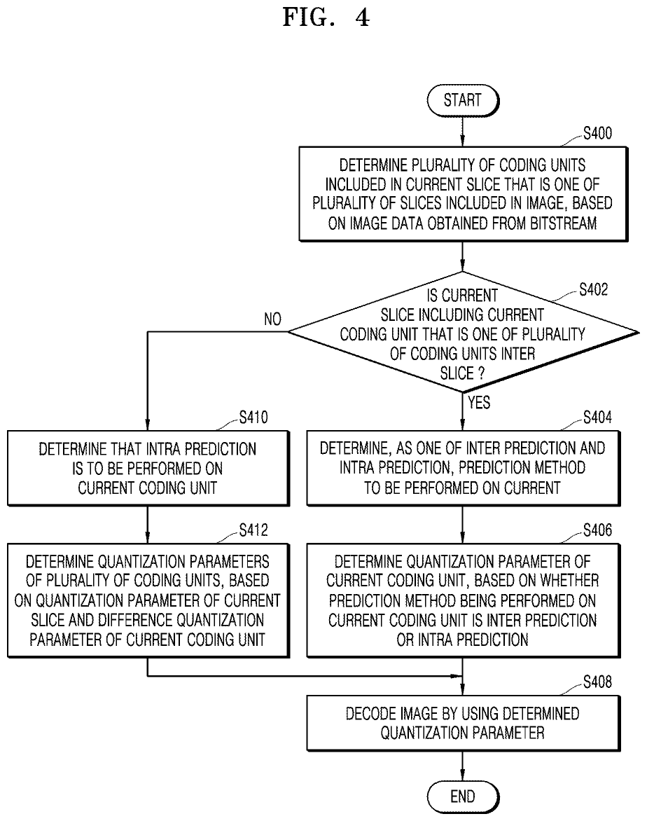

FIG. 4 is a flowchart of a process of determining a quantization parameter according to respective intra and inter coding units and decoding an image, according to an embodiment.

In operation S400, the decoder 120 may determine a plurality of coding units included in a current slice that is one of a plurality of slices included in the image, based on image data obtained from a bitstream. Features of operation S400 may be similar to those of operation S200, and thus detailed descriptions thereof are omitted.

In operation S402, the decoder 120 may determine whether the current slice including a current coding unit that is one of a plurality of coding units is an inter slice. According to an embodiment, the decoder 120 may determine, according to each of the slices, whether the current slice is an intra slice or the inter slice, based on slice type information obtained from a bitstream.

When the current slice is determined as the inter slice, the decoder 120 may determine, as one of inter prediction and intra prediction, a prediction method to be performed on the current coding unit, in operation S404. According to an embodiment, a coding unit included in the inter slice may be predicted by using one of intra prediction and inter prediction, and the decoder 120 may determine whether the current coding unit included in the inter slice is an inter coding unit on which inter prediction is to be performed. According to an embodiment, the prediction method of the current coding unit may be determined based on prediction mode information obtained from the bitstream according to each coding unit.

In operation S406, the decoder 120 may determine a quantization parameter of the current coding unit, based on whether the prediction method being performed on the current coding unit is inter prediction or intra prediction. According to an embodiment, the decoder 120 may determine a quantization parameter of an intra coding unit to be greater than a quantization parameter of an inter coding unit, wherein intra prediction is performed on the intra coding unit and inter prediction is performed on the inter coding unit.

In operation S402, when the current slice is determined to be the intra slice, in operation S410, the decoder 120 may determine that intra prediction is to be performed on the current coding unit. According to an embodiment, when the current slice is the intra slice, the decoder 120 may skip a process of obtaining the prediction mode information from the bitstream according to each coding unit included in the current slice, and may determine that only intra prediction is to be performed on at least one coding unit included in the current slice.

In operation S412, the decoder 120 may determine the quantization parameter of the current coding unit, based on a quantization parameter of the current slice and a difference quantization parameter of the current coding unit. According to an embodiment, the difference quantization parameter of the current coding unit is obtained from the bitstream according to each coding unit, and may refer to a difference value of the quantization parameter of the current coding unit with respect to the quantization parameter of the current slice. According to an embodiment, the difference quantization parameter may be determined regardless of a prediction mode of the current coding unit.

According to an embodiment, the decoder 120 may determine a quantization parameter for each coding unit, and the quantization parameter that is determined for each coding unit may be determined by using information obtained from the bitstream according to a data unit (e.g., a picture, a slice, or the like) that is larger than each coding unit. For example, the quantization parameter that is determined for each coding unit may be determined based on quantization parameter information obtained from the bitstream according to each picture, and quantization parameter information obtained from the bitstream according to each slice. For example, the quantization parameter that is determined for each coding unit may be determined by using Equation 1.

Qp=N+init_qp_minusN+slice_qp_delta+cu_qp_delta [Equation 1]

According to an embodiment, N indicates an integer determined based on the number of quantization parameters used in image encoding/decoding processes, and may be ½ of the number of quantization parameters used in the image encoding/decoding processes. According to an embodiment, init_qp_minusN indicates a value obtained by subtracting N from a quantization parameter value determined according to each picture. According to an embodiment, slice_qp_delta indicates a quantization parameter difference value determined according to each slice with respect to a quantization parameter of a picture. cu_qp_delta indicates a quantization parameter difference value determined according to each coding unit with respect to a quantization parameter determined according to each slice, and may be differently determined according to each coding unit, based on a prediction mode of each coding unit. However, a method that may be used in determining a quantization parameter of a current picture according to each coding unit is not limited to Equation 1, and should be broadly interpreted to the extent that one of ordinary skill in the art may differently determine a quantization parameter according to each coding unit by using quantization parameter information obtained according to each of data units having various sizes and including coding units, slices, pictures, or the like which are included therebetween.

In operation S408, the decoder 120 may decode the image by using the quantization parameter determined in operation S406 or S412.

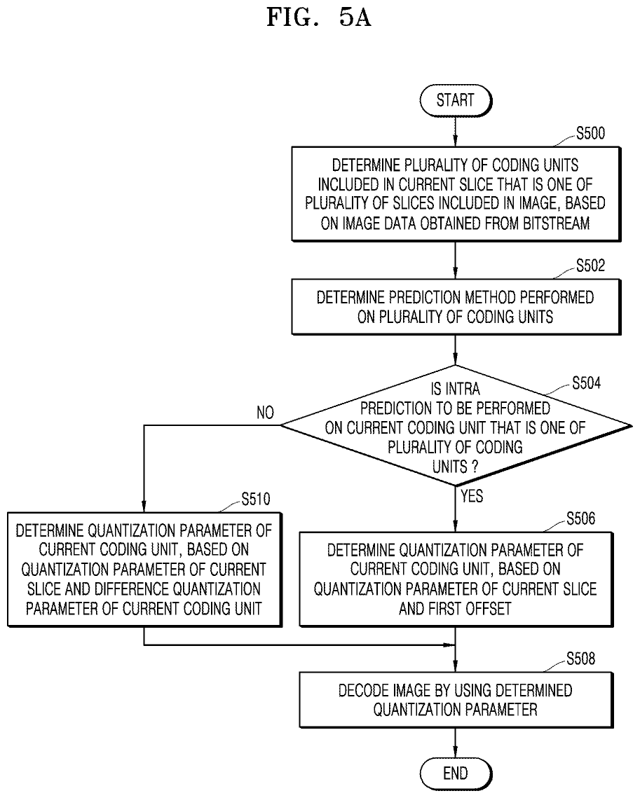

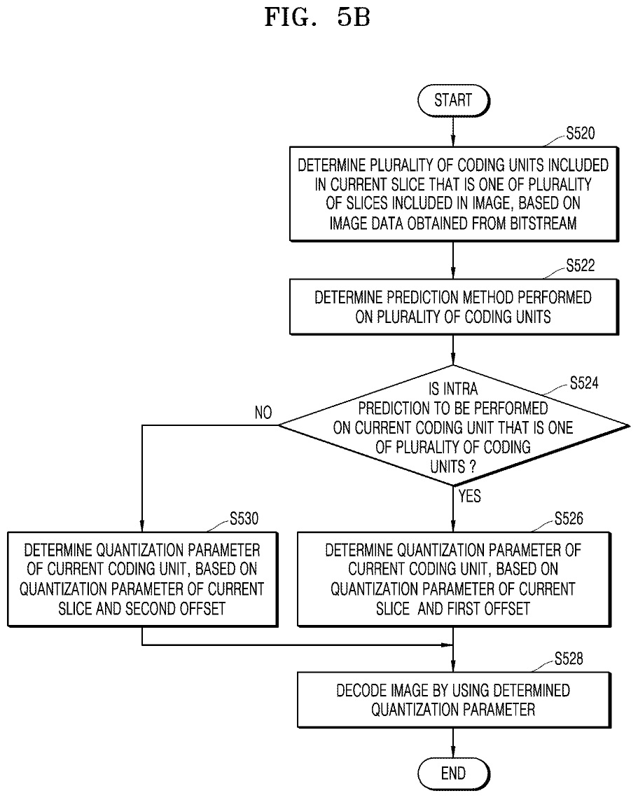

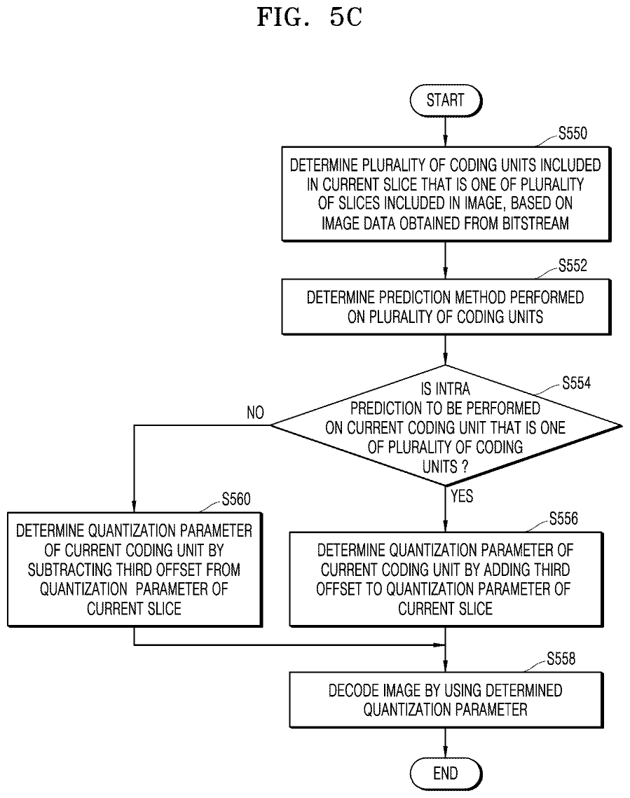

FIG. 5A is a flowchart of a method of determining a quantization parameter of an intra coding unit, according to an embodiment.

According to an embodiment, in operation S500, the decoder 120 may determine a plurality of coding units included in a current slice that is one of a plurality of slices included in the image, based on image data obtained from a bitstream. In operation S502, a prediction method performed on the plurality of coding units may be determined. Features of operations S500 to S502 may be similar to those of operations S200 to S202 of FIG. 2A, and thus detailed descriptions thereof are omitted.

In operation S504, the decoder 120 may determine whether intra prediction is to be performed on a current coding unit that is one of the plurality of coding units. According to an embodiment, the decoder 120 may determine which prediction mode is to be performed on the current coding unit, based on prediction mode information obtained according to each coding unit. According to an embodiment, when a current slice including the current coding unit is an intra slice, the decoder 120 may determine that an intra prediction mode is to be performed on the current coding unit even when the prediction mode information is not separately obtained.

When it is determined that intra prediction is to be performed on the current coding unit, in operation S506, the decoder 120 may determine a quantization parameter of the current coding unit, based on a quantization parameter of the current slice and a first offset.

According to an embodiment, to determine a quantization parameter according to each coding unit, the decoder 120 may determine whether intra prediction is to be performed on the current coding unit for which quantization parameter is to be determined, and may use the first offset so as to determine the quantization parameter of the intra coding unit that is a coding unit on which intra prediction is performed.

According to an embodiment, the decoder 120 may determine the quantization parameter of the current coding unit by using the first offset and the quantization parameter of the current slice. According to an embodiment, the decoder 120 may determine the quantization parameter of the intra coding unit by using Equation 2.

QP_intra=QP_slice+intraQP_offset [Equation 2]

According to an embodiment, QP_intra may indicate the quantization parameter of the intra coding unit. According to an embodiment, QP_slice may indicate the quantization parameter of the current slice, and may be a value obtained by adding a plurality of pieces of quantization parameter information obtained from each of a slice and various data units (e.g., a picture) including the slice. According to an embodiment, intraQP_offset indicates the first offset obtained from a bitstream. To determine the quantization parameter of the current coding unit on which intra prediction is performed, the first offset is added to reference quantization parameter information (e.g., QP_slice of a slice including the current coding unit), and the quantization parameter of the current coding unit may be determined as a quantization parameter that is greater than a quantization parameter of an inter coding unit.

According to an embodiment, when intra prediction is not performed on the current coding unit, in operation S510, the decoder 120 may determine the quantization parameter of the current coding unit, based on a quantization parameter of the current slice and a difference quantization parameter of the current coding unit. According to an embodiment, in a case of an inter coding unit that is different from the intra coding unit using the first offset, a quantization parameter may be determined based on the quantization parameter of the current slice without using the first offset. According to an embodiment, a difference corresponding to the first offset may be present between quantization parameters of an intra coding unit and inter coding unit which are included in a same slice. Features of operation S510 may be similar to those of operation S412 of FIG. 4, and thus detailed descriptions thereof are omitted.

In operation S508, the decoder 120 may decode an image by using the quantization parameter determined in operation S506 or S510.

FIG. 5B is a flowchart of a process of determining a quantization parameter of a current coding unit, based on a first offset or a second offset, according to an embodiment.

Features of operations S520 to S526 may be similar to those of operations S500 to S506 of FIG. 5A, and thus detailed descriptions thereof are omitted.

According to an embodiment, when it is determined that inter prediction, not intra prediction, is to be performed on the current coding unit, in operation S530, the decoder 120 may determine the quantization parameter of the current coding unit, based on a quantization parameter of a current slice and the second offset. According to an embodiment, the decoder 120 may determine a quantization parameter of an inter coding unit by using Equation 3.

QP_inter=QP_slice−interQP_offset [Equation 3]

According to an embodiment, QP_inter may indicate the quantization parameter of the inter coding unit. According to an embodiment, QP_slice may indicate the quantization parameter of the current slice, and may be a value obtained by adding a plurality of pieces of quantization parameter information obtained from each of a slice and various data units (e.g., a picture) including the slice. According to an embodiment, interQP_offset indicates the second offset obtained from a bitstream.

According to an embodiment, the decoder 120 may determine a quantization parameter of a coding unit on which intra prediction is performed, by adding the first offset to reference quantization parameter information (e.g., QP_slice of a slice including the current coding unit), and may determine a quantization parameter of a coding unit on which inter prediction is performed, by adding the second offset to the reference quantization parameter information. An offset may be added to all of a quantization parameter of an intra coding unit and the quantization parameter of the inter coding unit, but when the first offset and the second offset are positive numbers, a size of the first offset is greater than a size of the second offset. Accordingly, the decoder 120 may determine the quantization parameter of the intra coding unit to be greater than the quantization parameter of the inter coding unit from among coding units included in an inter slice.

In operation S528, the decoder 120 may decode an image by using the quantization parameter determined in operation S526 or S528.

FIG. 5C is a flowchart of a process of determining a quantization parameter of an intra coding unit and a quantization parameter of an inter coding unit, based on a third offset, according to an embodiment.

Features of operations S550 to S554 may be similar to those of operations S500 to S504 of FIG. 5A, and thus detailed descriptions thereof are omitted.

When it is determined that intra prediction is to be performed on the current coding unit, in operation S556, the decoder 120 may determine the quantization parameter of the current coding unit by adding the third offset to a quantization parameter of a current slice.

According to an embodiment, when it is determined that inter prediction, not intra prediction, is to be performed on the current coding unit, in operation S560, the decoder 120 may determine the quantization parameter of the current coding unit by subtracting the third offset from the quantization parameter of the current slice. According to an embodiment, the decoder 120 may determine the quantization parameters of the intra coding unit and inter coding unit by using Equation 4.

QP_intra=QP_slice+QP_offset

QP_inter=QP_slice−QP_offset [Equation 4]

According to an embodiment, QP_inter may indicate the quantization parameter of the inter coding unit. According to an embodiment, QP_slice may indicate the quantization parameter of the current slice, and may be a value obtained by adding a plurality of pieces of quantization parameter information obtained from each of a slice and various data units (e.g., a picture) including the slice. According to an embodiment, QP_offset indicates the third offset obtained from a bitstream.

According to an embodiment, the decoder 120 may determine a quantization parameter of a coding unit on which intra prediction is performed, by adding the third offset to reference quantization parameter information (e.g., QP_slice of a slice including the current coding unit), and may determine a quantization parameter of a coding unit on which inter prediction is performed, by adding the third offset to the reference quantization parameter information. Accordingly, the decoder 120 may determine the quantization parameter of the intra coding unit to be greater than the quantization parameter of the inter coding unit from among coding units included in an inter slice.

According to an embodiment, information about the aforementioned various offsets (the first offset, the second offset, and the third offset) may be obtained from the bitstream according to each of various data units including the current coding unit. According to an embodiment, offset information may be obtained from the bitstream according to each largest coding unit, each slice, each picture, each sequence, or the like which is a data unit including a coding unit. That is, first offsets of coding units on which intra prediction is performed from among a plurality of coding units included in a largest coding unit, a slice, a picture, a sequence, or the like may be equal to each other.

In operation S558, the decoder 120 may decode an image by using the quantization parameter determined in operation S556 or S560.

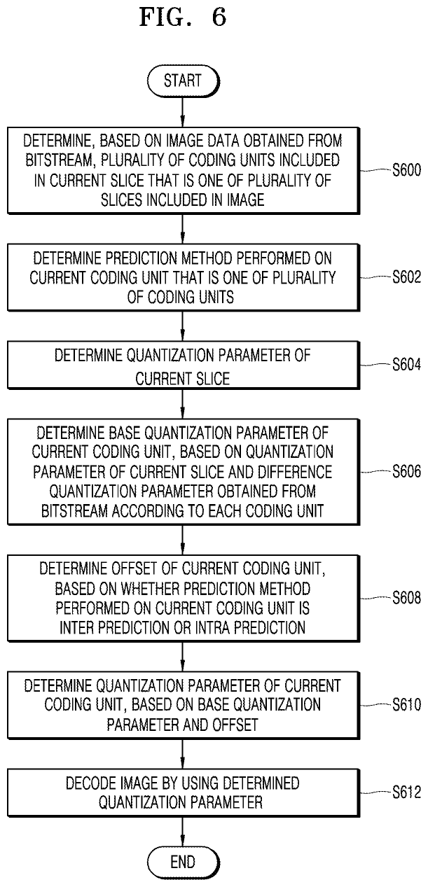

FIG. 6 is a flowchart of a process of determining a current quantization parameter of a coding unit by using a base quantization parameter and an offset, the base quantization parameter being determinable according to each coding unit, according to an embodiment.

In operation S600, the decoder 120 may determine, based on image data obtained from a bitstream, a plurality of coding units included in a current slice that is one of a plurality of slices included in an image. Features of operation S600 may be similar to those of operation S200, and thus detailed descriptions thereof are omitted.

In operation S602, the decoder 120 may determine whether the current slice including a current coding unit that is one of a plurality of coding units is an inter slice. According to an embodiment, the decoder 120 may determine, according to each of the slices, whether the current slice is an intra slice or the inter slice, based on slice type information obtained from a bitstream.

In operation S604, the decoder 120 may determine a quantization parameter of the current slice including the current coding unit. According to an embodiment, the quantization parameter of the current slice may be a value obtained by adding a plurality of pieces of quantization parameter information obtained from each of a slice and various data units (e.g., a picture) including the slice.

In operation S606, the decoder 120 may determine a base quantization parameter of the current coding unit, based on a quantization parameter of the current slice and a difference quantization parameter obtained from the bitstream according to each coding unit. According to an embodiment, the decoder 120 may determine a quantization parameter of the current coding unit, based on the quantization parameter of the current slice and the difference quantization parameter of the current coding unit. According to an embodiment, the difference quantization parameter of the current coding unit is obtained from the bitstream according to each coding unit, and may indicate a difference value of the quantization parameter of the current coding unit with respect to the quantization parameter of the current slice. According to an embodiment, the base quantization parameter may be a result obtained by adding the quantization parameter of the current slice and the difference quantization parameter of the current coding unit. According to an embodiment, the base quantization parameter of the current coding unit may be determined by using Equation 1 described above.

According to an embodiment, a difference quantization parameter may be determined regardless of a prediction mode of a coding unit. That is, difference quantization parameters of an intra coding unit and inter coding unit may be determined regardless of a prediction mode.

In operation S608, the decoder 120 may determine an offset of the current coding unit, based on whether a prediction method performed on the current coding unit is inter prediction or intra prediction. A method of determining an offset to be used in a current coding unit, based on a prediction method, has been described through various embodiments, and thus detailed descriptions thereof are omitted here.

In operation S610, the decoder 120 may determine a quantization parameter of the current coding unit, based on the base quantization parameter and the offset. According to an embodiment, the decoder 120 may determine the quantization parameter of the current coding unit by applying the offset to the base quantization parameter determined in operation S606. According to an embodiment, the offset may be added to or subtracted from a QP value of a base quantization parameter determined by using Equation 1. The offset that may be added or subtracted has been described through various embodiments, and thus detailed descriptions thereof are omitted here. According to an embodiment, the decoder 120 may determine the quantization parameter of the current coding unit by adding/subtracting at least one of the first offset, the second offset, and the third offset to/from the base quantization parameter.

In operation S612, the decoder 120 may decode an image by using the quantization parameter determined in operation S610.

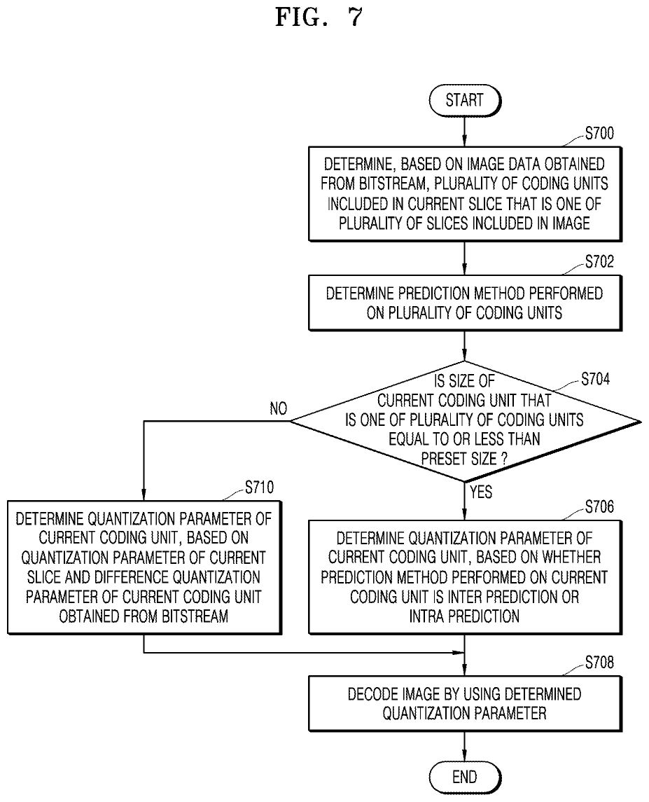

FIG. 7 illustrates a flowchart of a method of determining a quantization parameter of a current coding unit, based on a size and a prediction mode of a coding unit, according to an embodiment.

Features of operations S700 and S702 may be similar to those of operations S200 and S202 of FIG. 2, and thus detailed descriptions thereof are omitted.

In operation S704, the decoder 120 may determine whether a size of a current coding unit that is one of a plurality of coding units is equal to or less than a preset size. According to an embodiment, in consideration of the fact that a resultant image quality of intra prediction is better than a resultant image quality of inter prediction, the decoder 120 may perform inverse quantization on an intra coding unit by using a quantization parameter greater than a quantization parameter of an inter coding unit, wherein intra prediction is performed on the intra coding unit. However, in a case where the size of the current coding unit is large, when quantization is performed by using a great quantization parameter, an image quality may significantly deteriorate. Thus, the decoder 120 may determine the quantization parameter, in consideration of not only whether intra prediction is performed on the current coding unit and but also whether the size of the current coding unit is equal to or less than the preset size.

According to an embodiment, when the size of the current coding unit is determined to be equal to or less than the preset size, in operation S706, the decoder 120 may determine the quantization parameter of the current coding unit, based on whether a prediction method performed on the current coding unit is inter prediction or intra prediction. Features of operation S706 have been described through various embodiments of determining the quantization parameter of the current coding unit, based on a prediction mode, and thus detailed descriptions thereof are omitted here.

According to an embodiment, when the size of the current coding unit is determined to greater than the preset size, in operation S710, the decoder 120 may determine the quantization parameter of the current coding unit, based on a quantization parameter of a current slice and a difference quantization parameter of the current coding unit obtained from a bitstream. When the size of the current coding unit is greater than the preset size, the decoder 120 may determine, regardless of a prediction mode of a coding unit, the quantization parameter of the current coding unit based on a difference quantization parameter determined according to each coding unit.

In operation S708, the decoder 120 may decode an image by using the quantization parameter determined in operation S706 or S710.

According to an embodiment, after the decoder 120 determines whether a prediction mode of the current coding unit is an intra prediction mode, the decoder 120 may determine whether the size of the current coding unit on which the intra prediction mode is performed is equal to or less than the preset size. According to an embodiment, when the current coding unit is an intra coding unit, the decoder 120 may determine the quantization parameter of the current coding unit, based on whether the size is equal to or less than the preset size. For example, in a case where the current coding unit is the intra coding unit and has the size being equal to or less than the preset size, a process of determining a quantization parameter of a coding unit may be performed according to the offset information (e.g., the first offset, the second offset, and the third offset). As another example, in a case where the current coding unit that is the intra coding unit has a size being greater than the preset size, a process of determining a quantization parameter (e.g., operation S710) may be performed by using a difference quantization parameter that is determined regardless of a prediction mode.

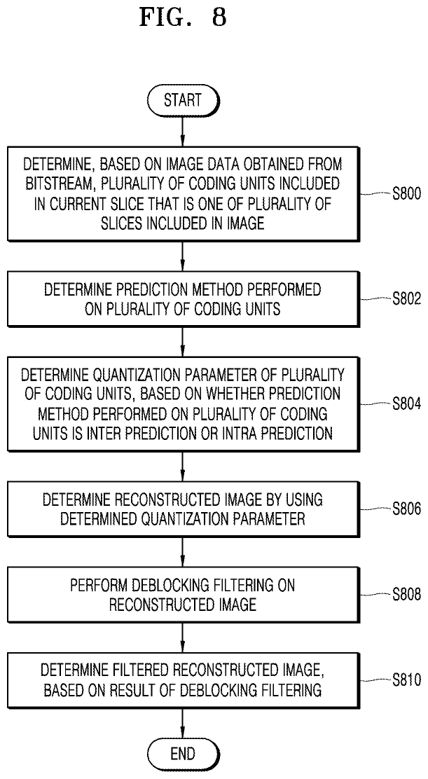

FIG. 8 illustrates a flowchart of a method of performing deblocking filtering by using a quantization parameter determined based on a prediction mode of a coding unit, according to an embodiment.

Features of operations S800 to S804 may be similar to those of operations S200 to S204 of FIG. 2, and thus detailed descriptions thereof are omitted.

In operation S806, the decoder 120 may determine a reconstructed image by using the determined quantization parameter. According to an embodiment, the reconstructed image may correspond to a decoded image before in-loop filtering is performed. The decoder 120 may perform a decoding process (e.g., an inverse transform process) by using the quantization parameter determined in operation S806 before in-loop filtering is performed.

In operation S808, the decoder 120 may perform deblocking filtering as in-loop filtering based on the reconstructed image determined in operation S806.

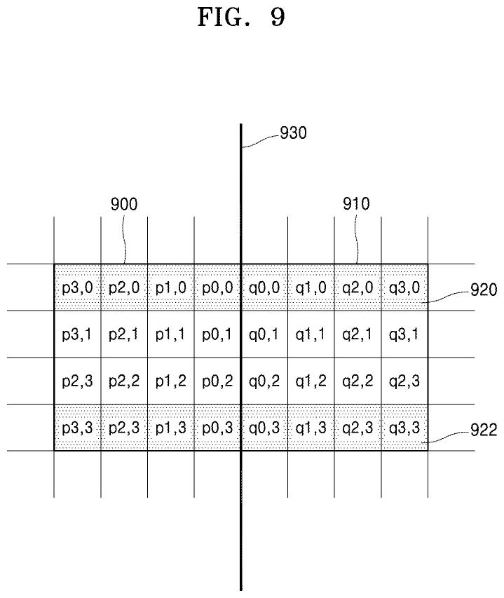

FIG. 9 illustrates a process of performing deblocking filtering by using a quantization parameter determined based on a prediction mode of a coding unit, according to an embodiment.

According to an embodiment, the decoder 120 may perform deblocking filtering on at least one boundary among a coding unit, a prediction unit, and a transform unit. According to an embodiment, the decoder 120 may determine a method of performing deblocking filtering by using a quantization parameter with respect to blocks 900 and 910 adjacent to a boundary 930 on which deblocking filtering is performed. For example, the decoder 120 may determine whether deblocking filtering is to be performed by using quantization parameters determined in operation S804, and may determine strength of deblocking filtering (e.g., strong filtering or weak filtering).

According to an embodiment, the decoder 120 may determine whether filtering is to be performed, by using the quantization parameter determined in operation S804, on a coding unit including the blocks 900 and 910 adjacent to the boundary 930 of deblocking filtering. For example, to determine whether deblocking filtering in a horizontal direction is to be performed, the decoder 120 may determine a variation of sample values of a first row 920 and fourth row 922 of the blocks 900 and 910 adjacent to the boundary 930 of deblocking filtering, and may determine an average value of the quantization parameters of the blocks 900 and 910. The decoder 120 may use the quantization parameters determined in operation S804 so as to determine the average value of the quantization parameters of the blocks 900 and 910. The decoder 120 may determine a certain value corresponding to the average value of the quantization parameters of the blocks 900 and 910, based on a predetermined table, and may compare the certain value with variation of sample values of first and fourth rows, thereby determining whether deblocking filtering is to be performed.

According to an embodiment, the decoder 120 may calculate an average value of the quantization parameters determined in operation S804 with respect to the coding unit including the blocks 900 and 910, and may determine a certain value corresponding to the calculated average value of the quantization parameters, based on the predetermined table. The decoder 120 may determine strength of deblocking filtering (e.g., strong filtering or weak filtering) by using the certain value.

According to an embodiment, the decoder 120 may determine, according to each picture, whether a quantization parameter of a current slice is equal to a quantization parameter determined based on a prediction mode of a current coding unit, based on information obtained according to each picture. When it is determined that it is possible to determine whether the quantization parameter of the current slice is equal to the quantization parameter determined based on the prediction mode of the current coding unit in a current picture, a difference quantization parameter indicating a difference may be determined, the difference being between the quantization parameter of the current slice and the quantization parameter determined based on the prediction mode of the current coding unit.

However, methods of performing deblocking filtering based on a quantization parameter are not limited to the aforementioned embodiment, and should be broadly interpreted to the extent that one of ordinary skill in the art may perform various methods of performing deblocking filtering based on a quantization parameter.

According to an embodiment, the decoder 120 may perform the aforementioned various embodiments only when a current slice included in a current picture is a slice including a block to be referred to when inter prediction is performed in another picture. According to an embodiment, when a reference block used in an inter prediction process with respect to a picture different from a picture including a current slice, the decoder 120 may determine a quantization parameter of a current coding unit, in consideration of a prediction mode of the current coding unit included in the current slice. A method, performed by the decoder 120, of determining the quantization parameter of the current coding unit by referring to the prediction mode of the current coding unit has been described above through various embodiments, and thus detailed descriptions thereof are omitted here.

Hereinafter, an image encoding apparatus that performs an image encoding method that is opposite or similar to the image decoding method will now be described through various embodiments.

FIG. 1B is a block diagram of an image encoding apparatus 150 capable of determining a quantization parameter of a coding unit by referring to a prediction method of the coding unit, according to an embodiment.

According to an embodiment, the image encoding apparatus 150 may include a bitstream generator 160 and an encoder 170, wherein the bitstream generator 160 is configured to generate a bitstream including image data corresponding to a result of encoding an image, and the encoder 170 is configured to determine a plurality of coding units included in a current slice that is one of a plurality of slices included in the image, to determine a prediction method performed on a current coding unit that is one of the plurality of coding units, to determine a quantization parameter of the current coding unit, based on whether the prediction method performed on the current coding unit is inter prediction or intra prediction, and to encode the image by using the determined quantization parameter. Hereinafter, the image encoding method performed by the bitstream generator 160 and the encoder 170 will now be described through various embodiments.

FIG. 2B is a flowchart for describing an image encoding method that may be performed by the image encoding apparatus 150, according to an embodiment.

In operation S210, the encoder 170 of the image encoding apparatus 150 may determine a plurality of coding units included in a current slice that is one of a plurality of slices included in an image. According to an embodiment, the image may include a plurality of pictures, and each of the pictures may be partitioned into various data units. According to an embodiment, each picture may be partitioned into various data units including tiles, slices, slice segments, largest coding units, or the like. According to an embodiment, each of the tiles, the slices, and the slice segments may include an integer number of largest coding units. The largest coding units may each be recursively partitioned based on partitioning information of a coding unit, and thus each of the largest coding units may include at least one coding unit.

In operation S212, the image encoding apparatus 150 may determine respective prediction methods to be performed on the plurality of coding units determined in operation S210. According to an embodiment, the encoder 170 may determine which prediction is to be performed on each coding unit. According to an embodiment, a prediction performing method may include various prediction methods including intra prediction and inter prediction.

According to an embodiment, the encoder 170 may determine at least one slice included in a current picture, and may determine a plurality of coding units included in each slice. The encoder 170 may determine whether a type of a slice including a current coding unit is an intra slice or an inter slice, according to each of the plurality of coding units.

According to an embodiment, when the current coding unit is determined to be included in the inter slice, the encoder 170 may determine that intra prediction or inter prediction is to be performed on the current coding unit. According to an embodiment, when the current coding unit is determined to be included in the intra slice, the encoder 170 may determine that intra prediction is to be performed on the current coding unit. According to an embodiment, when the current coding unit is determined to be included in the intra slice, the image encoding apparatus 150 may determine that the current coding unit is to be predicted according to an intra prediction mode that is a predetermined prediction mode.

FIG. 3 is a diagram illustrating a relation among slices and coding units, the slices configuring an image and the coding units being included in a largest coding unit, according to an embodiment.

According to an embodiment, the image encoding apparatus 150 may determine whether a current slice is an intra slice or an inter slice, according to each of a plurality of slices configuring an image. According to an embodiment, the current picture 300 may include the intra slices 302 and 308, the uni-direction inter slice 304, the bi-direction inter slice 306, or the like.

According to an embodiment, the encoder 170 may determine a prediction mode of a coding unit included in the intra slices 302 and 308. The encoder 170 according to an embodiment may determine at least one coding unit by recursively partitioning a largest coding unit (e.g., a unit 303) included in one of the intra slices 302, and may determine a prediction mode of the at least one coding unit to be an intra prediction mode.

In operation S214, the encoder 170 may determine a quantization parameter of the current coding unit based on whether the prediction method performed on the current coding unit is inter prediction or intra prediction.

According to an embodiment, the encoder 170 may determine the quantization parameter, based on whether the prediction method of the current coding unit is intra prediction or inter prediction, the prediction method being determined in operation S212. According to an embodiment, the encoder 170 may determine a quantization parameter of an intra coding unit to be greater than a quantization parameter of an inter coding unit, wherein intra prediction is performed on the intra coding unit and inter prediction is performed on the inter coding unit. A process of determining a quantization parameter will be described in detail through various embodiments.

In operation S216, the encoder 170 may encode the image by using the quantization parameter determined in operation S214, and the bitstream generator 160 may generate a bitstream including information about the encoded image. The image encoding method using a quantization parameter may include various methods. According to an embodiment, the encoder 170 may perform a quantization process on a residual signal of the image by using the quantization parameter determined in operation S214. According to an embodiment, the encoder 170 may perform deblocking filtering based on the quantization parameter determined in operation S214.

According to an embodiment, the encoder 170 may determine a plurality of coding units included in a current slice that is one of a plurality of slices included in an image. According to an embodiment, the encoder 170 may determine whether a current slice including a current coding unit that is one of the plurality of coding units is an inter slice. According to an embodiment, the encoder 170 may determine whether the current slice is an intra slice or an inter slice.

According to an embodiment, when the current slice is determined as the inter slice, the encoder 170 may determine, as one of inter prediction and intra prediction, a prediction method to be performed on the current coding unit in operation S404. According to an embodiment, a coding unit included in the inter slice may be predicted by using one of intra prediction and inter prediction, and the encoder 170 may determine whether the current coding unit included in the inter slice is an inter coding unit on which inter prediction is to be performed.

The encoder 170 may determine a quantization parameter of the current coding unit, based on whether the prediction method being performed on the current coding unit is inter prediction or intra prediction. According to an embodiment, the encoder 170 may determine a quantization parameter of an intra coding unit to be greater than a quantization parameter of an inter coding unit, wherein intra prediction is performed on the intra coding unit and inter prediction is performed on the inter coding unit.

When the current slice is determined to be the intra slice, the encoder 170 may determine that intra prediction is to be performed on the current coding unit. According to an embodiment, when the current slice is the intra slice, the encoder 170 may determine that only intra prediction is to be performed on at least one coding unit included in the current slice, and furthermore, the bitstream generator 160 may skip a process of generating a bitstream including prediction mode information, according to each coding unit included in the current slice.

The encoder 170 may determine the quantization parameter of the current coding unit, based on a quantization parameter of the current slice and a difference quantization parameter of the current coding unit. According to an embodiment, the difference quantization parameter of the current coding unit may refer to a difference value of the quantization parameter of the current coding unit with respect to the quantization parameter of the current slice. According to an embodiment, the difference quantization parameter may be determined regardless of a prediction mode of the current coding unit.

According to an embodiment, the encoder 170 may determine a quantization parameter for each coding unit, and the quantization parameter that is determined for each coding unit may be determined according to a data unit (e.g., a picture, a slice, or the like) that is larger than each coding unit. For example, the quantization parameter that is determined for each coding unit may be determined based on quantization parameter information determined according to each picture, and quantization parameter information determined according to each slice. For example, the quantization parameter that is determined for each coding unit may be determined by using Equation 1 described above.

According to an embodiment, the encoder 170 may encode the image by using the determined quantization parameter, and may generate a bitstream including information about the encoded image.

According to an embodiment, the encoder 170 may determine whether intra prediction is to be performed on the current coding unit that is one of the plurality of coding units. The bitstream generator 160 may generate the bitstream including prediction mode information indicating a prediction mode to be performed on the current coding unit. According to an embodiment, when the current slice including the current coding unit is an intra slice, the encoder 170 may skip a process of determining whether an inter prediction mode is performed on the current coding unit, and the bitstream generator 160 may skip a process of generating a bitstream including prediction mode information about the plurality of coding units included in the current slice.

When it is determined that intra prediction is performed on the current coding unit, the encoder 170 may determine the quantization parameter of the current coding unit, based on the quantization parameter of the current slice and a first offset.

According to an embodiment, to determine a quantization parameter according to each coding unit, the encoder 170 may determine whether intra prediction is to be performed on the current coding unit for which quantization parameter is to be determined, and may use the first offset so as to determine the quantization parameter of the intra coding unit that is a coding unit on which intra prediction is performed.

According to an embodiment, the encoder 170 may determine the quantization parameter of the current coding unit by using the first offset and the quantization parameter of the current slice. According to an embodiment, the encoder 170 may determine the quantization parameter of the intra coding unit by using Equation 2 described above.

According to an embodiment, when intra prediction is not performed on the current coding unit, the encoder 170 may determine the quantization parameter of the current coding unit, based on the quantization parameter of the current slice and the difference quantization parameter of the current coding unit. According to an embodiment, in a case of an inter coding unit that is different from the intra coding unit using the first offset, a quantization parameter may be determined based on the quantization parameter of the current slice without using the first offset. According to an embodiment, a difference corresponding to the first offset may be present between quantization parameters of an intra coding unit and inter coding unit which are included in a same slice.

According to an embodiment, when it is determined that inter prediction, not intra prediction, is to be performed on the current coding unit, the encoder 170 may determine the quantization parameter of the current coding unit, based on the quantization parameter of the current slice and a second offset. According to an embodiment, the encoder 170 may determine a quantization parameter of an inter coding unit by using Equation 3 described above.

According to an embodiment, the encoder 170 may determine the quantization parameter of the coding unit on which intra prediction is performed, by adding the first offset to reference quantization parameter information (e.g., QP_slice of a slice including the current coding unit), and may determine the quantization parameter of the coding unit on which inter prediction is performed, by adding the second offset to the reference quantization parameter information. An offset may be added to all of the quantization parameter of the intra coding unit and the quantization parameter of the inter coding unit, but when the first offset and the second offset are positive numbers, a size of the first offset is greater than a size of the second offset. Accordingly, the encoder 170 may determine the quantization parameter of the intra coding unit to be greater than the quantization parameter of the inter coding unit from among coding units included in an inter slice.

When it is determined that intra prediction is to be performed on the current coding unit, the encoder 170 may determine the quantization parameter of the current coding unit by adding a third offset to the quantization parameter of the current slice.

According to an embodiment, when it is determined that inter prediction, not intra prediction, is to be performed on the current coding unit, the encoder 170 may determine the quantization parameter of the current coding unit by subtracting the third offset from the quantization parameter of the current slice. According to an embodiment, the encoder 170 may determine the quantization parameters of the intra coding unit and inter coding unit by using Equation 4 described above.

According to an embodiment, the encoder 170 may determine the quantization parameter of the coding unit on which intra prediction is performed, by adding the third offset to reference quantization parameter information (e.g., QP_slice of a slice including the current coding unit), and may determine a quantization parameter of a coding unit on which inter prediction is performed, by adding the third offset to the reference quantization parameter information. Accordingly, the encoder 170 may determine the quantization parameter of the intra coding unit to be greater than the quantization parameter of the inter coding unit from among coding units included in an inter slice.

According to an embodiment, the bitstream generator 160 may generate a bitstream including information about the aforementioned various offsets (the first offset, the second offset, and the third offset) according to each of various data units including the current coding unit. According to an embodiment, the bitstream generator 160 may generate a bitstream including offset information according to each largest coding unit, each slice, each picture, each sequence, or the like which is a data unit including a coding unit. That is, first offsets of coding units on which intra prediction is performed from among a plurality of coding units included in a largest coding unit, a slice, a picture, a sequence, or the like may be equal to each other.

According to an embodiment, the encoder 170 may use the aforementioned various offsets so as to determine the quantization parameter of the current coding unit, based on a prediction mode, and the bitstream generator 160 may generate a bitstream including information about an encoded image by using the determined quantization parameter.

According to an embodiment, the encoder 170 may determine the quantization parameter of the current slice including the current coding unit. According to an embodiment, the quantization parameter of the current slice may be a value obtained by adding a plurality of pieces of quantization parameter information obtained from each of a slice and various data units (e.g., a picture) including the slice.

According to an embodiment, the encoder 170 may determine the quantization parameter of the current slice and a difference quantization parameter of the current coding unit, and may determine the quantization parameter of the current coding unit, based on the quantization parameter of the current slice and the difference quantization parameter of the current coding unit. According to an embodiment, the difference quantization parameter of the current coding unit may indicate a difference value of the quantization parameter of the current coding unit with respect to the quantization parameter of the current slice. According to an embodiment, a base quantization parameter may be a result obtained by adding the quantization parameter of the current slice and the difference quantization parameter of the current coding unit. According to an embodiment, the base quantization parameter of the current coding unit may be determined by using Equation 1 described above. The bitstream generator 160 may generate a bitstream including the quantization parameter of the current slice, the difference quantization parameter, and the base quantization parameter which are determined by the encoder 170.

According to an embodiment, the difference quantization parameter may be determined regardless of a prediction mode of a coding unit. That is, difference quantization parameters of the intra coding unit and inter coding unit may be determined regardless of a prediction mode.

According to an embodiment, the encoder 170 may determine the quantization parameter of the current coding unit, based on the base quantization parameter and the offset. According to an embodiment, the encoder 170 may determine the quantization parameter of the current coding unit by applying the offset to the base quantization parameter. According to an embodiment, the offset may be added to or subtracted from a QP value of a base quantization parameter determined by using Equation 1. The offset that may be added or subtracted has been described through various embodiments, and thus detailed descriptions thereof are omitted here. According to an embodiment, the encoder 170 may determine the quantization parameter of the current coding unit by adding/subtracting at least one of the first offset, the second offset, and the third offset to/from the base quantization parameter.

According to an embodiment, the encoder 170 may determine whether the current coding unit that is one of the plurality of coding units is equal to or less than a preset size. According to an embodiment, in consideration of the fact that a resultant image quality of intra prediction is better than a resultant image quality of inter prediction, the encoder 170 may perform inverse quantization on an intra coding unit by using a quantization parameter greater than a quantization parameter of an inter coding unit, wherein intra prediction is performed on the intra coding unit. However, in a case where a size of the current coding unit is large, when quantization is performed by using a great quantization parameter, an image quality may significantly deteriorate. Thus, the encoder 170 may determine the quantization parameter, in consideration of not only whether intra prediction is performed on the current coding unit and but also whether the size of the current coding unit is equal to or less than the preset size.

According to an embodiment, when the size of the current coding unit is determined to be equal to or less than the preset size, the encoder 170 may determine the quantization parameter of the current coding unit, based on whether a prediction method performed on the current coding unit is inter prediction or intra prediction. A method of determining the quantization parameter of the current coding unit, based on a prediction mode, have been described through various embodiments and thus detailed descriptions thereof are omitted here.

According to an embodiment, when the size of the current coding unit is determined to greater than the preset size, in operation S710, the encoder 170 may determine the quantization parameter of the current coding unit, based on the quantization parameter of the current slice and the difference quantization parameter of the current coding unit. When the size of the current coding unit is greater than the preset size, the encoder 170 may determine, regardless of a prediction mode of a coding unit, the quantization parameter of the current coding unit based on a difference quantization parameter determined according to each coding unit.

According to an embodiment, after the encoder 170 determines whether the prediction mode of the current coding unit is an intra prediction mode, the encoder 170 may determine whether the size of the current coding unit on which the intra prediction mode is performed is equal to or less than the preset size. According to an embodiment, when the current coding unit is an intra coding unit, the encoder 170 may determine the quantization parameter of the current coding unit, based on whether the size is equal to or less than the preset size. For example, in a case where the current coding unit is the intra coding unit and has the size being equal to or less than the preset size, a process of determining a quantization parameter of a coding unit may be performed according to the offset information (e.g., the first offset, the second offset, and the third offset). As another example, in a case where the current coding unit that is the intra coding unit has a size being greater than the preset size, a process of determining a quantization parameter (e.g., operation S710) may be performed by using the difference quantization parameter that is determined regardless of the prediction mode.

According to an embodiment, the encoder 170 may determine a reconstructed image by using the quantization parameter. According to an embodiment, the reconstructed image may correspond to an image on which encoding and decoding has been performed before in-loop filtering is performed. The encoder 170 may perform, by using the quantization parameter, encoding and decoding processes (e.g., transform and inverse transform processes) before in-loop filtering is performed.

According to an embodiment, the encoder 170 may perform deblocking filtering as in-loop filtering on the reconstructed image. According to an embodiment, the encoder 170 may perform deblocking filtering on at least one boundary among a coding unit, a prediction unit, and a transform unit. According to an embodiment, the encoder 170 may determine a method of performing deblocking filtering by using a quantization parameter with respect to the blocks 900 and 910 adjacent to the boundary 930 on which deblocking filtering is performed. For example, the encoder 170 may determine whether deblocking filtering is to be performed by using quantization parameters, and may determine strength of deblocking filtering (e.g., strong filtering or weak filtering).

According to an embodiment, the encoder 170 may determine whether filtering is to be performed, by using the quantization parameter determined in operation S804, on a coding unit including the blocks 900 and 910 adjacent to the boundary 930 of deblocking filtering. For example, to determine whether deblocking filtering in a horizontal direction is to be performed, the encoder 170 may determine a variation of sample values of a first row 920 and fourth row 922 of the blocks 900 and 910 adjacent to the boundary 930 of deblocking filtering, and may determine an average value of the quantization parameters of the blocks 900 and 910. The encoder 170 may use the quantization parameters determined in operation S804 so as to determine the average value of the quantization parameters of the blocks 900 and 910. The encoder 170 may determine a certain value corresponding to the average value of the quantization parameters of the blocks 900 and 910, based on a predetermined table, and may compare the certain value with variation of sample values of first and fourth rows, thereby determining whether deblocking filtering is to be performed.

According to an embodiment, the encoder 170 may calculate an average value of the quantization parameters of the blocks 900 and 910, and may determine a certain value corresponding to the calculated average value of the quantization parameters, based on the predetermined table. The quantization parameters of the blocks 900 and 910 may be determined through the aforementioned various embodiments, the quantization parameters being determined according to each coding unit base on the prediction mode. The encoder 170 may determine strength of deblocking filtering (e.g., strong filtering or weak filtering) by using the certain value.

According to an embodiment, the encoder 170 may determine, according to each picture, whether the quantization parameter of the current slice is equal to the quantization parameter determined based on the prediction mode of the current coding unit. When it is determined that it is possible to determine whether the quantization parameter of the current slice is equal to the quantization parameter determined based on the prediction mode of the current coding unit in a current picture, a difference quantization parameter indicating a difference may be determined, the difference being between the quantization parameter of the current slice and the quantization parameter determined based on the prediction mode of the current coding unit.

According to an embodiment, the encoder 170 may perform the aforementioned various embodiments only when a current slice included in a current picture is a slice including a block to be referred to when inter prediction is performed in another picture. According to an embodiment, when a reference block used in an inter prediction process with respect to a picture different from a picture including a current slice, the encoder 170 may determine a quantization parameter of a current coding unit, in consideration of a prediction mode of the current coding unit included in the current slice. A method, performed by the encoder 170, of determining the quantization parameter of the current coding unit by referring to the prediction mode of the current coding unit has been described above through various embodiments, and thus detailed descriptions thereof are omitted here.

However, methods of performing deblocking filtering based on a quantization parameter are not limited to the aforementioned embodiment, and should be broadly interpreted to the extent that one of ordinary skill in the art may perform various methods of performing deblocking filtering based on a quantization parameter.

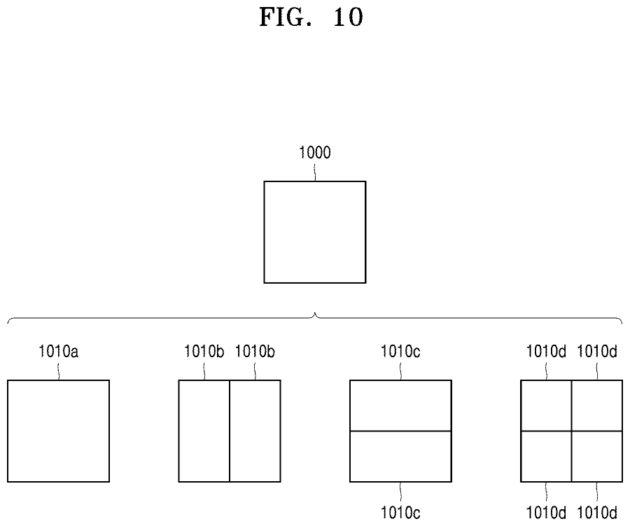

Hereinafter, a method of determining a data unit of an image according to an embodiment will be described with reference to FIGS. 10 to 23.

FIG. 10 illustrates an operation, performed by the image decoding apparatus 100, of determining one or more coding units by partitioning a current coding unit, according to an embodiment.

According to an embodiment, the image decoding apparatus 100 may determine a shape of a coding unit by using block shape information, and may determine a partitioning method of the coding unit by using partition shape information. That is, a coding unit partitioning method indicated by the partition shape information may be determined based on a block shape indicated by the block shape information used by the image decoding apparatus 100.

According to an embodiment, the image decoding apparatus 100 may use the block shape information indicating that the current coding unit has a square shape. For example, the image decoding apparatus 100 may determine whether not to partition a square coding unit, whether to vertically partition the square coding unit, whether to horizontally partition the square coding unit, or whether to partition the square coding unit into four coding units, based on the partition shape information. Referring to FIG. 10, when the block shape information of a current coding unit 1000 indicates a square shape, a decoder 1030 may determine that a coding unit 1010a having the same size as the current coding unit 1000 is not partitioned, based on the partition shape information indicating not to perform partitioning, or may determine coding units 1010b, 1010c, or 1010d partitioned based on the partition shape information indicating a predetermined partitioning method.

Referring to FIG. 10, according to an embodiment, the image decoding apparatus 100 may determine two coding units 1010b obtained by partitioning the current coding unit 1000 in a vertical direction, based on the partition shape information indicating to perform partitioning in a vertical direction. The image decoding apparatus 100 may determine two coding units 1010c obtained by partitioning the current coding unit 1000 in a horizontal direction, based on the partition shape information indicating to perform partitioning in a horizontal direction. The image decoding apparatus 100 may determine four coding units 1010d obtained by partitioning the current coding unit 1000 in vertical and horizontal directions, based on the partition shape information indicating to perform partitioning in vertical and horizontal directions. However, partitioning methods of the square coding unit are not limited to the above-described methods, and the partition shape information may indicate various methods. Predetermined partitioning methods of partitioning the square coding unit will be described in detail below in relation to various embodiments.

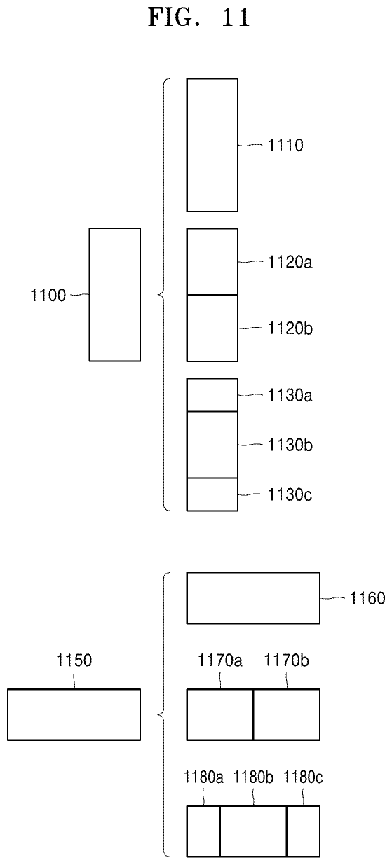

FIG. 11 illustrates an operation, performed by the image decoding apparatus 100, of determining one or more coding units by partitioning a non-square coding unit, according to an embodiment.

According to an embodiment, the image decoding apparatus 100 may use block shape information indicating that a current coding unit has a non-square shape. The image decoding apparatus 100 may determine whether not to partition the non-square current coding unit or whether to partition the non-square current coding unit by using a predetermined partitioning method, based on partition shape information. Referring to FIG. 11, when the block shape information of a current coding unit 1100 or 1150 indicates a non-square shape, the image decoding apparatus 100 may determine that a coding unit 1110 or 1160 having the same size as the current coding unit 1100 or 1150 is not partitioned, based on the partition shape information indicating not to perform partitioning, or determine coding units 1120a and 1120b, 1130a to 1130c, 1170a and 1170b, or 1180a to 1180c partitioned based on the partition shape information indicating a predetermined partitioning method. Predetermined partitioning methods of partitioning a non-square coding unit will be described in detail below in relation to various embodiments.

According to an embodiment, the image decoding apparatus 100 may determine a partitioning method of a coding unit by using the partition shape information and, in this case, the partition shape information may indicate the number of one or more coding units generated by partitioning a coding unit. Referring to FIG. 11, when the partition shape information indicates to partition the current coding unit 1100 or 1150 into two coding units, the image decoding apparatus 100 may determine two coding units 1120a and 1120b, or 1170a and 1170b included in the current coding unit 1100 or 1150, by partitioning the current coding unit 1100 or 1150 based on the partition shape information.

According to an embodiment, when the image decoding apparatus 100 partitions the non-square current coding unit 1100 or 1150 based on the partition shape information, the location of a long side of the non-square current coding unit 1100 or 1150 may be considered. For example, the image decoding apparatus 100 may determine a plurality of coding units by dividing a long side of the current coding unit 1100 or 1150 considering the shape of the current coding unit 1100 or 1150.

According to an embodiment, when the partition shape information indicates to partition a coding unit into an odd number of blocks, the image decoding apparatus 100 may determine an odd number of coding units included in the current coding unit 1100 or 1150. For example, when the partition shape information indicates to partition the current coding unit 1100 or 1150 into three coding units, the image decoding apparatus 100 may partition the current coding unit 1100 or 1150 into three coding units 1130a, 1130b, and 1130c, or 1180a, 1180b, and 1180c. According to an embodiment, the image decoding apparatus 100 may determine an odd number of coding units included in the current coding unit 1100 or 1150, and not all the determined coding units have the same size. For example, a predetermined coding unit 1130b or 1180b from among the determined odd number of coding units 1130a, 1130b, and 1130c, or 1180a, 1180b, and 1180c may have a size different from the size of the other coding units 1130a and 1130c, or 1180a and 1180c. That is, coding units which may be determined by partitioning the current coding unit 1100 or 1150 may have multiple sizes and, in some cases, all of the odd number of coding units 1130a, 1130b, and 1130c, or 1180a, 1180b, and 1180c may have different sizes.

According to an embodiment, when the partition shape information indicates to partition a coding unit into an odd number of blocks, the image decoding apparatus 100 may determine an odd number of coding units included in the current coding unit 1100 or 1150, and may put a predetermined restriction on at least one coding unit from among the odd number of coding units generated by partitioning the current coding unit 1100 or 1150. Referring to FIG. 11, the image decoding apparatus 100 may allow a decoding method of the coding unit 1130b or 1180b to be different from that of the other coding units 1130a and 1130c, or 1180a and 1180c, wherein the coding unit 1130b or 1180b is at a center location from among the three coding units 1130a, 1130b, and 1130c, or 1180a, 1180b, and 1180c generated by partitioning the current coding unit 1100 or 1150. For example, the image decoding apparatus 100 may restrict the coding unit 1130b or 1180b at the center location to be no longer partitioned or to be partitioned by only a predetermined number of times, unlike the other coding units 1130a and 1130c, or 1180a and 1180c.

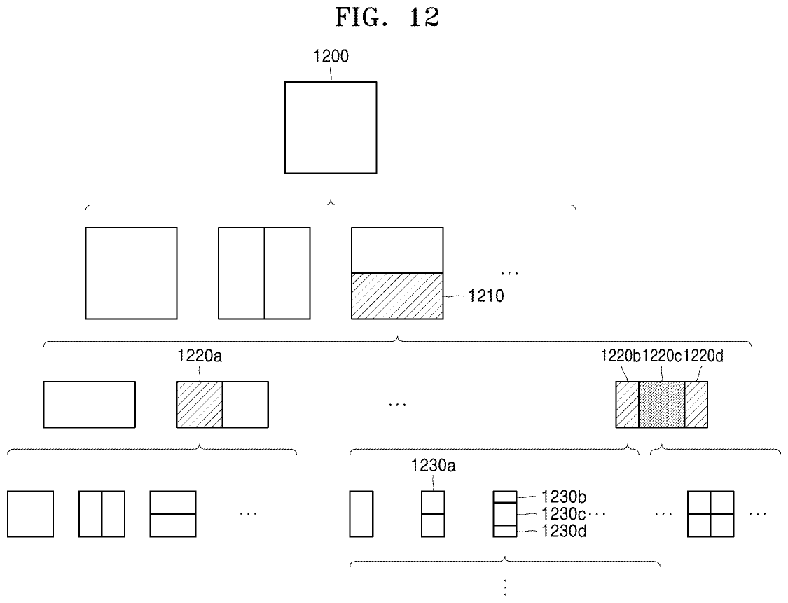

FIG. 12 illustrates an operation, performed by the image decoding apparatus 100, of partitioning a coding unit based on at least one of block shape information and partition shape information, according to an embodiment.

According to an embodiment, the image decoding apparatus 100 may determine to or not to partition a square first coding unit 1200 into coding units, based on at least one of the block shape information and the partition shape information. According to an embodiment, when the partition shape information indicates to partition the first coding unit 1200 in a horizontal direction, the image decoding apparatus 100 may determine a second coding unit 1210 by partitioning the first coding unit 1200 in a horizontal direction. A first coding unit, a second coding unit, and a third coding unit used according to an embodiment are terms used to understand a relation before and after partitioning a coding unit. For example, a second coding unit may be determined by partitioning a first coding unit, and a third coding unit may be determined by partitioning the second coding unit. It will be understood that the structure of the first, second, and third coding units follows the above descriptions.

According to an embodiment, the image decoding apparatus 100 may determine to or not to partition the determined second coding unit 1210 into coding units, based on at least one of the block shape information and the partition shape information. Referring to FIG. 12, the image decoding apparatus 100 may or may not partition the non-square second coding unit 1210, which is determined by partitioning the first coding unit 1200, into one or more third coding units 1220a, or 1220b, 1220c, and 1220d based on at least one of the block shape information and the partition shape information. The image decoding apparatus 100 may obtain at least one of the block shape information and the partition shape information, and determine a plurality of various-shaped second coding units (e.g., 1210) by partitioning the first coding unit 1200, based on the obtained at least one of the block shape information and the partition shape information, and the second coding unit 1210 may be partitioned by using the partitioning method of the first coding unit 1200, based on at least one of the block shape information and the partition shape information. According to an embodiment, when the first coding unit 1200 is partitioned into the second coding units 1210 based on at least one of the block shape information and the partition shape information of the first coding unit 1200, the second coding unit 1210 may also be partitioned into the third coding units 1220a, or 1220b, 1220c, and 1220d based on at least one of the block shape information and the partition shape information of the second coding unit 1210. That is, a coding unit may be recursively partitioned based on at least one of the block shape information and the partition shape information of each coding unit. Therefore, a square coding unit may be determined by partitioning a non-square coding unit, and a non-square coding unit may be determined by recursively partitioning the square coding unit. Referring to FIG. 12, a predetermined coding unit from among an odd number of third coding units 1220b, 1220c, and 1220d determined by partitioning the non-square second coding unit 1210 (e.g., a coding unit at a center location or a square coding unit) may be recursively partitioned. According to an embodiment, the square third coding unit 1220c from among the odd number of third coding units 1220b, 1220c, and 1220d may be partitioned in a horizontal direction into a plurality of fourth coding units. A non-square fourth coding unit 1240 from among the plurality of fourth coding units may be partitioned into a plurality of coding units. For example, the non-square fourth coding unit 1240 may be partitioned into an odd number of coding units 1250a, 1250b, and 1250c.

A method that may be used to recursively partition a coding unit will be described below in relation to various embodiments.

According to an embodiment, the image decoding apparatus 100 may determine to partition each of the third coding units 1220a, or 1220b, 1220c, and 1220d into coding units or not to partition the second coding unit 1210, based on at least one of the block shape information and the partition shape information. According to an embodiment, the image decoding apparatus 100 may partition the non-square second coding unit 1210 into the odd number of third coding units 1220b, 1220c, and 1220d. The image decoding apparatus 100 may put a predetermined restriction on a predetermined third coding unit from among the odd number of third coding units 1220b, 1220c, and 1220d. For example, the image decoding apparatus 100 may restrict a coding unit 1220c at a center location from among the odd number of third coding units 1220b, 1220c, and 1220d to be no longer partitioned or to be partitioned by a settable number of times. Referring to FIG. 12, the image decoding apparatus 100 may restrict a coding unit 1220c, which is at the center location from among the odd number of third coding units 1220b, 1220c, and 1220d included in the non-square second coding unit 1210, to be no longer partitioned, to be partitioned by using a predetermined partitioning method (e.g., partitioned into only four coding units or partitioned by using a partitioning method of the second coding unit 1210), or to be partitioned by only a predetermined number of times (e.g., partitioned by only n times (where n>0)). However, the restrictions on the coding unit 1220c at the center location are not limited to the above-described examples, and may include various restrictions for decoding the coding unit 1220c at the center location differently from the other coding units 1220b and 1220d.

According to an embodiment, the image decoding apparatus 100 may obtain at least one of the block shape information and the partition shape information, which is used to partition a current coding unit, from a predetermined location in the current coding unit.

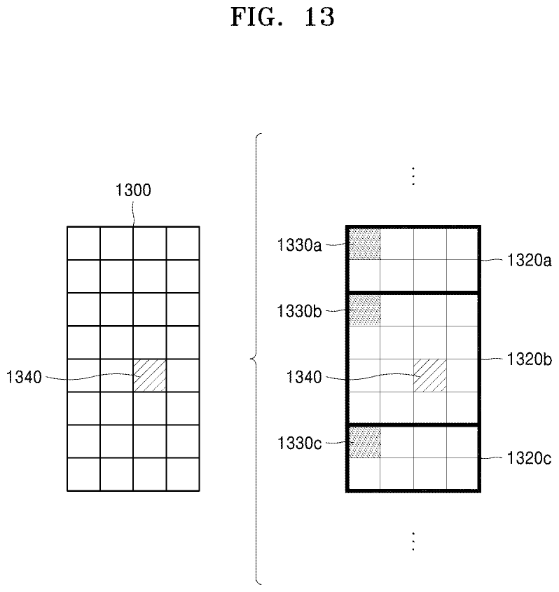

FIG. 13 illustrates a method, performed by the image decoding apparatus 100, of determining a predetermined coding unit from among an odd number of coding units, according to an embodiment. Referring to FIG. 13, at least one of block shape information and partition shape information of a current coding unit 1300 may be obtained from a sample of a predetermined location from among a plurality of samples included in the current coding unit 1300 (e.g., a sample 1340 of a center location). However, the predetermined location in the current coding unit 1300, from which at least one of the block shape information and the partition shape information may be obtained, is not limited to the center location in FIG. 13, and may include various locations included in the current coding unit 1300 (e.g., top, bottom, left, right, top left, bottom left, top right, and bottom right locations). The image decoding apparatus 100 may obtain at least one of the block shape information and the partition shape information from the predetermined location and determine to or not to partition the current coding unit into various-shaped and various-sized coding units.

According to an embodiment, when the current coding unit is partitioned into a predetermined number of coding units, the image decoding apparatus 100 may select one of the coding units. Various methods may be used to select one of a plurality of coding units, as will be described below in relation to various embodiments.

According to an embodiment, the image decoding apparatus 100 may partition the current coding unit into a plurality of coding units, and may determine a coding unit at a predetermined location.

FIG. 13 illustrates a method, performed by the image decoding apparatus 100, of determining a coding unit of a predetermined location from among an odd number of coding units, according to an embodiment.

According to an embodiment, the image decoding apparatus 100 may use information indicating locations of the odd number of coding units, to determine a coding unit at a center location from among the odd number of coding units. Referring to FIG. 13, the image decoding apparatus 100 may determine an odd number of coding units 1320a, 1320b, and 1320c by partitioning the current coding unit 1300. The image decoding apparatus 100 may determine a coding unit 1320b at a center location by using information about locations of the odd number of coding units 1320a to 1320c. For example, the image decoding apparatus 100 may determine the coding unit 1320b of the center location by determining the locations of the coding units 1320a, 1320b, and 1320c based on information indicating locations of predetermined samples included in the coding units 1320a, 1320b, and 1320c. In detail, the image decoding apparatus 100 may determine the coding unit 1320b at the center location by determining the locations of the coding units 1320a, 1320b, and 1320c based on information indicating locations of top left samples 1330a, 1330b, and 1330c of the coding units 1320a, 1320b, and 1320c.

According to an embodiment, the information indicating the locations of the top left samples 1330a, 1330b, and 1330c, which are included in the coding units 1320a, 1320b, and 1320c, respectively, may include information about locations or coordinates of the coding units 1320a, 1320b, and 1320c in a picture. According to an embodiment, the information indicating the locations of the top left samples 1330a, 1330b, and 1330c, which are included in the coding units 1320a, 1320b, and 1320c, respectively, may include information indicating widths or heights of the coding units 1320a, 1320b, and 1320c included in the current coding unit 1300, and the widths or heights may correspond to information indicating differences between the coordinates of the coding units 1320a, 1320b, and 1320c in the picture. That is, the image decoding apparatus 100 may determine the coding unit 1320b at the center location by directly using the information about the locations or coordinates of the coding units 1320a, 1320b, and 1320c in the picture, or by using the information about the widths or heights of the coding units, which correspond to the difference values between the coordinates.

According to an embodiment, information indicating the location of the top left sample 1330a of the upper coding unit 1320a may include coordinates (xa, ya), information indicating the location of the top left sample 1330b of the middle coding unit 1320b may include coordinates (xb, yb), and information indicating the location of the top left sample 1330c of the lower coding unit 1320c may include coordinates (xc, yc). The image decoding apparatus 100 may determine the middle coding unit 1320b by using the coordinates of the top left samples 1330a, 1330b, and 1330c which are included in the coding units 1320a, 1320b, and 1320c, respectively. For example, when the coordinates of the top left samples 1330a, 1330b, and 1330c are sorted in an ascending or descending order, the coding unit 1320b including the coordinates (xb, yb) of the sample 1330b at a center location may be determined as a coding unit at a center location from among the coding units 1320a, 1320b, and 1320c determined by partitioning the current coding unit 1300. However, the coordinates indicating the locations of the top left samples 1330a, 1330b, and 1330c may include coordinates indicating absolute locations in the picture, or may use coordinates (dxb, dyb) indicating a relative location of the top left sample 1330b of the middle coding unit 1320b and coordinates (dxc, dyc) indicating a relative location of the top left sample 1330c of the lower coding unit 1320c with reference to the location of the top left sample 1330a of the upper coding unit 1320a. A method of determining a coding unit at a predetermined location by using coordinates of a sample included in the coding unit, as information indicating a location of the sample, is not limited to the above-described method, and may include various arithmetic methods capable of using the coordinates of the sample.

According to an embodiment, the image decoding apparatus 100 may partition the current coding unit 1300 into a plurality of coding units 1320a, 1320b, and 1320c, and select one of the coding units 1320a, 1320b, and 1320c based on a predetermined criterion. For example, the image decoding apparatus 100 may select the coding unit 1320b, which has a size different from that of the others, from among the coding units 1320a, 1320b, and 1320c.

According to an embodiment, the image decoding apparatus 100 may determine the widths or heights of the coding units 1320a, 1320b, and 1320c by using the coordinates (xa, ya) indicating the location of the top left sample 1330a of the upper coding unit 1320a, the coordinates (xb, yb) indicating the location of the top left sample 1330b of the middle coding unit 1320b, and the coordinates (xc, yc) indicating the location of the top left sample 1330c of the lower coding unit 1320c. The image decoding apparatus 100 may determine the sizes of the coding units 1320a, 1320b, and 1320c by using the coordinates (xa, ya), (xb, yb), and (xc, yc) indicating the locations of the coding units 1320a, 1320b, and 1320c.

According to an embodiment, the image decoding apparatus 100 may determine the width of the upper coding unit 1320a to be xb-xa and determine the height thereof to be yb-ya. According to an embodiment, the image decoding apparatus 100 may determine the width of the middle coding unit 1320b to be xc-xb and determine the height thereof to be yc-yb. According to an embodiment, the image decoding apparatus 100 may determine the width or height of the lower coding unit 1320c by using the width or height of the current coding unit 1300 or the widths or heights of the upper and middle coding units 1320a and 1320b. The image decoding apparatus 100 may determine a coding unit, which has a size different from that of the others, based on the determined widths and heights of the coding units 1320a to 1320c. Referring to FIG. 13, the image decoding apparatus 100 may determine the middle coding unit 1320b, which has a size different from the size of the upper and lower coding units 1320a and 1320c, as the coding unit of the predetermined location. However, the above-described method, performed by the image decoding apparatus 100, of determining a coding unit having a size different from the size of the other coding units merely corresponds to an example of determining a coding unit at a predetermined location by using the sizes of coding units, which are determined based on coordinates of samples, and thus various methods of determining a coding unit at a predetermined location by comparing the sizes of coding units, which are determined based on coordinates of predetermined samples, may be used.

However, locations of samples considered to determine locations of coding units are not limited to the above-described top left locations, and information about arbitrary locations of samples included in the coding units may be used.

According to an embodiment, the image decoding apparatus 100 may select a coding unit at a predetermined location from among an odd number of coding units determined by partitioning the current coding unit, considering the shape of the current coding unit. For example, when the current coding unit has a non-square shape, a width of which is longer than a height, the image decoding apparatus 100 may determine the coding unit at the predetermined location in a horizontal direction. That is, the image decoding apparatus 100 may determine one of coding units at different locations in a horizontal direction and put a restriction on the coding unit. When the current coding unit has a non-square shape, a height of which is longer than a width, the image decoding apparatus 100 may determine the coding unit at the predetermined location in a vertical direction. That is, the image decoding apparatus 100 may determine one of coding units at different locations in a vertical direction and put a restriction on the coding unit.

According to an embodiment, the image decoding apparatus 100 may use information indicating locations of an even number of coding units, to determine the coding unit at the predetermined location from among the even number of coding units. The image decoding apparatus 100 may determine an even number of coding units by partitioning the current coding unit, and determine the coding unit at the predetermined location by using the information about the locations of the even number of coding units. An operation related thereto may correspond to the operation of determining a coding unit at a predetermined location (e.g., a center location) from among an odd number of coding units, which has been described in detail above in relation to FIG. 13, and thus detailed descriptions thereof are not provided here.

According to an embodiment, when a non-square current coding unit is partitioned into a plurality of coding units, predetermined information about a coding unit at a predetermined location may be used in a partitioning operation to determine the coding unit at the predetermined location from among the plurality of coding units. For example, the image decoding apparatus 100 may use at least one of block shape information and partition shape information, which is stored in a sample included in a coding unit at a center location, in a partitioning operation to determine the coding unit at the center location from among the plurality of coding units determined by partitioning the current coding unit.

Referring to FIG. 13, the image decoding apparatus 100 may partition the current coding unit 1300 into a plurality of coding units 1320a, 1320b, and 1320c based on at least one of the block shape information and the partition shape information, and determine a coding unit 1320b at a center location from among the plurality of the coding units 1320a, 1320b, and 1320c. Furthermore, the image decoding apparatus 100 may determine the coding unit 1320b at the center location, in consideration of a location from which at least one of the block shape information and the partition shape information is obtained. That is, at least one of the block shape information and the partition shape information of the current coding unit 1300 may be obtained from the sample 1340 at a center location of the current coding unit 1300 and, when the current coding unit 1300 is partitioned into the plurality of coding units 1320a, 1320b, and 1320c based on at least one of the block shape information and the partition shape information, the coding unit 1320b including the sample 1340 may be determined as the coding unit at the center location. However, information used to determine the coding unit at the center location is not limited to at least one of the block shape information and the partition shape information, and various types of information may be used to determine the coding unit at the center location.

According to an embodiment, predetermined information for identifying the coding unit at the predetermined location may be obtained from a predetermined sample included in a coding unit to be determined. Referring to FIG. 13, the image decoding apparatus 100 may use at least one of the block shape information and the partition shape information, which is obtained from a sample at a predetermined location in the current coding unit 1300 (e.g., a sample at a center location of the current coding unit 1300) to determine a coding unit at a predetermined location from among the plurality of the coding units 1320a, 1320b, and 1320c determined by partitioning the current coding unit 1300 (e.g., a coding unit at a center location from among a plurality of partitioned coding units). That is, the image decoding apparatus 100 may determine the sample at the predetermined location by considering a block shape of the current coding unit 1300, determine the coding unit 1320b including a sample, from which predetermined information (e.g., at least one of the block shape information and the partition shape information) may be obtained, from among the plurality of coding units 1320a, 1320b, and 1320c determined by partitioning the current coding unit 1300, and put a predetermined restriction on the coding unit 1320b. Referring to FIG. 13, according to an embodiment, the image decoding apparatus 100 may determine the sample 1340 at the center location of the current coding unit 1300 as the sample from which the predetermined information may be obtained, and put a predetermined restriction on the coding unit 1320b including the sample 1340, in a decoding operation. However, the location of the sample from which the predetermined information may be obtained is not limited to the above-described location, and may include arbitrary locations of samples included in the coding unit 1320b to be determined for a restriction.

According to an embodiment, the location of the sample from which the predetermined information may be obtained may be determined based on the shape of the current coding unit 1300. According to an embodiment, the block shape information may indicate whether the current coding unit has a square or non-square shape, and the location of the sample from which the predetermined information may be obtained may be determined based on the shape. For example, the image decoding apparatus 100 may determine a sample located on a boundary for dividing at least one of a width and height of the current coding unit in half, as the sample from which the predetermined information may be obtained, by using at least one of information about the width of the current coding unit and information about the height of the current coding unit. As another example, when the block shape information of the current coding unit indicates a non-square shape, the image decoding apparatus 100 may determine one of samples adjacent to a boundary for dividing a long side of the current coding unit in half, as the sample from which the predetermined information may be obtained.

According to an embodiment, when the current coding unit is partitioned into a plurality of coding units, the image decoding apparatus 100 may use at least one of the block shape information and the partition shape information to determine a coding unit at a predetermined location from among the plurality of coding units. According to an embodiment, the image decoding apparatus 100 may obtain at least one of the block shape information and the partition shape information from a sample at a predetermined location in a coding unit, and partition the plurality of coding units, which are generated by partitioning the current coding unit, by using at least one of the partition shape information and the block shape information, which is obtained from the sample of the predetermined location in each of the plurality of coding units. That is, a coding unit may be recursively partitioned based on at least one of the block shape information and the partition shape information, which is obtained from the sample of the predetermined location in each coding unit. An operation of recursively partitioning a coding unit has been described above in relation to FIG. 12, and thus detailed descriptions thereof will not be provided herein.

According to an embodiment, the image decoding apparatus 100 may determine one or more coding units by partitioning the current coding unit, and determine an order of decoding the one or more coding units, based on a predetermined block (e.g., the current coding unit).

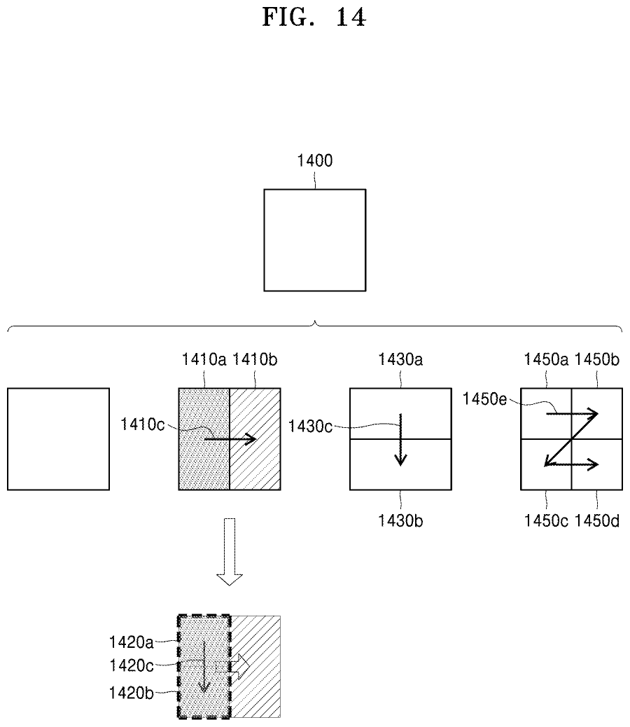

FIG. 14 illustrates a processing order of a plurality of coding units when the image decoding apparatus 100 determines the plurality of coding units by partitioning a current coding unit, according to an embodiment.

According to an embodiment, the image decoding apparatus 100 may determine second coding units 1410a and 1410b by partitioning a first coding unit 1400 in a vertical direction, determine second coding units 1430a and 1430b by partitioning the first coding unit 1400 in a horizontal direction, or determine second coding units 1450a to 1450d by partitioning the first coding unit 1400 in vertical and horizontal directions, based on block shape information and partition shape information.

Referring to FIG. 14, the image decoding apparatus 100 may determine to process the second coding units 1410a and 1410b, which are determined by partitioning the first coding unit 1400 in a vertical direction, in a horizontal direction order 1410c. The image decoding apparatus 100 may determine to process the second coding units 1430a and 1430b, which are determined by partitioning the first coding unit 1400 in a horizontal direction, in a vertical direction order 1430c. The image decoding apparatus 100 may determine to process the second coding units 1450a to 1450d, which are determined by partitioning the first coding unit 1400 in vertical and horizontal directions, in a predetermined order for processing coding units in a row and then processing coding units in a next row (e.g., in a raster scan order or Z-scan order 1450e).

According to an embodiment, the image decoding apparatus 100 may recursively partition coding units. Referring to FIG. 14, the image decoding apparatus 100 may determine a plurality of coding units 1410a, 1410b, 1430a, 1430b, 1450a, 1450b, 1450c, and 1450d by partitioning the first coding unit 1400, and recursively partition each of the determined plurality of coding units 1410a, 1410b, 1430a, 1430b, 1450a, 1450b, 1450c, and 1450d. A partitioning method of the plurality of coding units 1410a, 1410b, 1430a, 1430b, 1450a, 1450b, 1450c, and 1450d may correspond to a partitioning method of the first coding unit 1400. As such, each of the plurality of coding units 1410a, 1410b, 1430a, 1430b, 1450a, 1450b, 1450c, and 1450d may be independently partitioned into a plurality of coding units. Referring to FIG. 14, the image decoding apparatus 100 may determine the second coding units 1410a and 1410b by partitioning the first coding unit 1400 in a vertical direction, and determine to independently partition or not to partition each of the second coding units 1410a and 1410b.

According to an embodiment, the image decoding apparatus 100 may determine third coding units 1420a and 1420b by partitioning the left second coding unit 1410a in a horizontal direction, and may not partition the right second coding unit 1410b.

According to an embodiment, a processing order of coding units may be determined based on an operation of partitioning a coding unit. In other words, a processing order of partitioned coding units may be determined based on a processing order of coding units immediately before being partitioned. The image decoding apparatus 100 may determine a processing order of the third coding units 1420a and 1420b determined by partitioning the left second coding unit 1410a, independently of the right second coding unit 1410b. Since the third coding units 1420a and 1420b are determined by partitioning the left second coding unit 1410a in a horizontal direction, the third coding units 1420a and 1420b may be processed in a vertical direction order 1420c. Since the left and right second coding units 1410a and 1410b are processed in the horizontal direction order 1410c, the right second coding unit 1410b may be processed after the third coding units 1420a and 1420b included in the left second coding unit 1410a are processed in the vertical direction order 1420c. An operation of determining a processing order of coding units based on a coding unit before being partitioned is not limited to the above-described example, and various methods may be used to independently process coding units, which are partitioned and determined to various shapes, in a predetermined order.

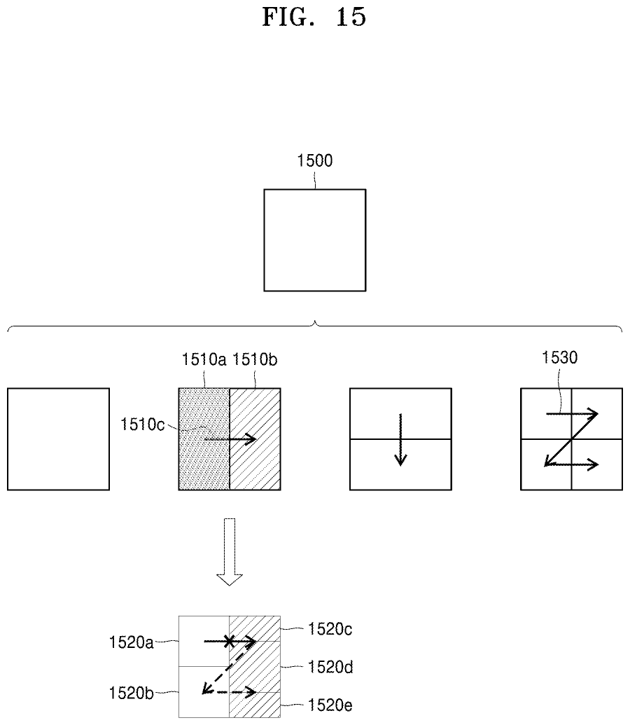

FIG. 15 illustrates an operation, performed by the image decoding apparatus 100, of determining that a current coding unit is partitioned into an odd number of coding units, when the coding units are not processable in a predetermined order, according to an embodiment.

According to an embodiment, the image decoding apparatus 100 may determine whether the current coding unit is partitioned into an odd number of coding units, based on obtained block shape information and partition shape information. Referring to FIG. 15, a square first coding unit 1500 may be partitioned into non-square second coding units 1510a and 1510b, and the second coding units 1510a and 1510b may be independently partitioned into third coding units 1520a and 1520b, and 1520c to 1520e. According to an embodiment, the image decoding apparatus 100 may determine a plurality of third coding units 1520a and 1520b by partitioning the left second coding unit 1510a in a horizontal direction, and partition the right second coding unit 1510b into an odd number of third coding units 1520c to 1520e.

According to an embodiment, the image decoding apparatus 100 may determine whether any coding unit is partitioned into an odd number of coding units, by deciding whether the third coding units 1520a and 1520b, and 1520c to 1520e are processable in a predetermined order. Referring to FIG. 15, the image decoding apparatus 100 may determine the third coding units 1520a and 1520b, and 1520c to 1520e by recursively partitioning the first coding unit 1500. The image decoding apparatus 100 may determine whether any of the first coding unit 1500, the second coding units 1510a and 1510b, and the third coding units 1520a and 1520b, and 1520c to 1520e is partitioned into an odd number of coding units, based on at least one of the block shape information and the partition shape information. For example, the right second coding unit 1510b may be partitioned into an odd number of third coding units 1520c to 1520e. A processing order of a plurality of coding units included in the first coding unit 1500 may be a predetermined order (e.g., a Z-scan order 1530), and the image decoding apparatus 100 may decide whether the third coding units 1520c to 1520e, which are determined by partitioning the right second coding unit 1510b into an odd number of coding units, satisfy a condition for processing in the predetermined order.

According to an embodiment, the image decoding apparatus 100 may determine whether the third coding units 1520a and 1520b, and 1520c to 1520e included in the first coding unit 1500 satisfy the condition for processing in the predetermined order, and the condition relates to whether at least one of a width and height of the second coding units 1510a and 1510b is divided in half along a boundary of the third coding units 1520a and 1520b, and 1520c to 1520e. For example, the third coding units 1520a and 1520b determined by dividing the height of the non-square left second coding unit 1510a in half satisfy the condition. However, since boundaries of the third coding units 1520c to 1520e determined by partitioning the right second coding unit 1510b into three coding units do not divide the width or height of the right second coding unit 1510b in half, it may be determined that the third coding units 1520c to 1520e do not satisfy the condition. When the condition is not satisfied as described above, the image decoding apparatus 100 may decide disconnection of a scan order, and determine that the right second coding unit 1510b is partitioned into an odd number of coding units, based on the result of decision. According to an embodiment, when a coding unit is partitioned into an odd number of coding units, the image decoding apparatus 100 may put a predetermined restriction on a coding unit of a predetermined location among the partitioned coding units. The restriction or the predetermined location has been described above in relation to various embodiments, and thus a detailed description thereof will not be provided herein.

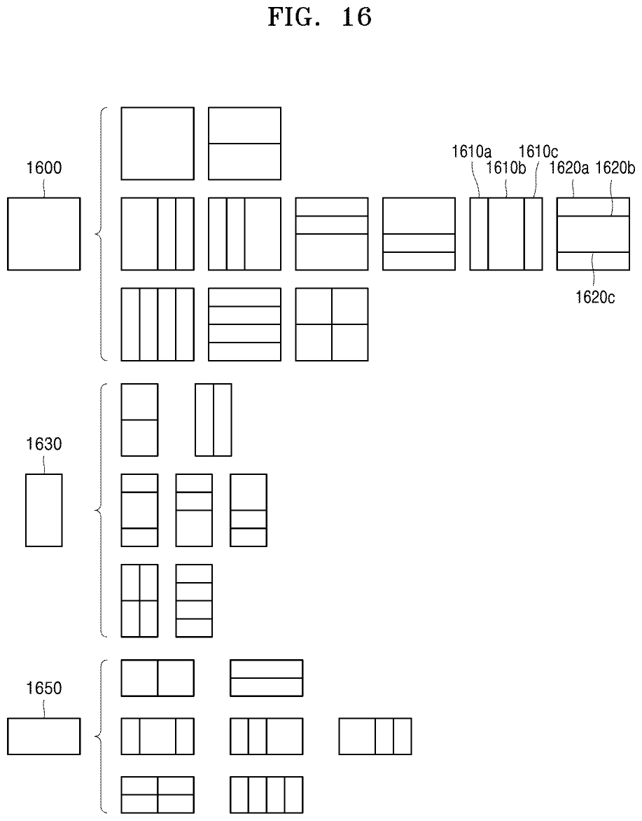

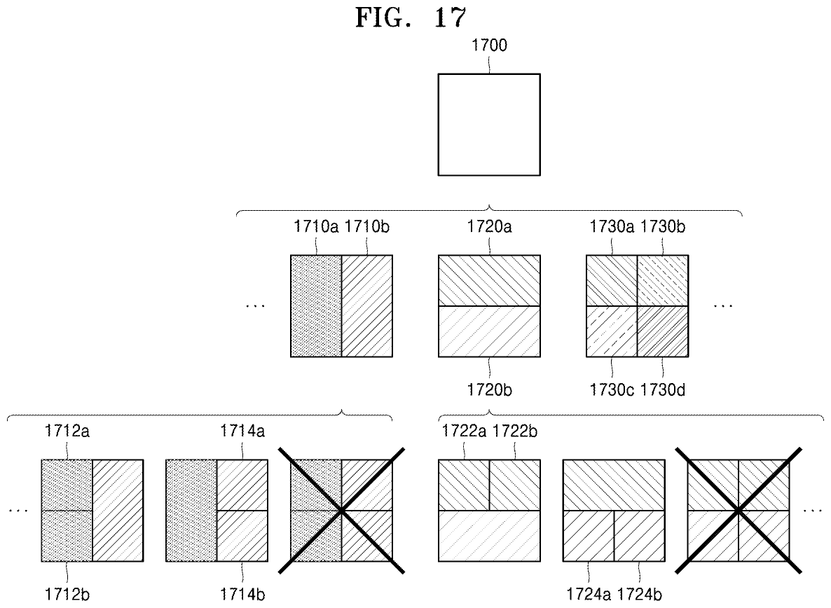

FIG. 16 illustrates an operation, performed by the image decoding apparatus 100, of determining one or more coding units by partitioning a first coding unit 1600, according to an embodiment. According to an embodiment, the image decoding apparatus 100 may partition the first coding unit 1600, based on at least one of block shape information and partition shape information, which is obtained by a receiver 210. The square first coding unit 1600 may be partitioned into four square coding units or into a plurality of non-square coding units. For example, referring to FIG. 16, when the block shape information indicates that the first coding unit 1600 has a square shape and the partition shape information indicates to partition the first coding unit 1600 into non-square coding units, the image decoding apparatus 100 may partition the first coding unit 1600 into a plurality of non-square coding units. In detail, when the partition shape information indicates to determine an odd number of coding units by partitioning the first coding unit 1600 in a horizontal direction or a vertical direction, the image decoding apparatus 100 may partition the square first coding unit 1600 into an odd number of coding units, e.g., second coding units 1610a, 1610b, and 1610c determined by partitioning the square first coding unit 1600 in a vertical direction or second coding units 1620a, 1620b, and 1620c determined by partitioning the square first coding unit 1600 in a horizontal direction.

According to an embodiment, the image decoding apparatus 100 may determine whether the second coding units 1610a, 1610b, 1610c, 1620a, 1620b, and 1620c included in the first coding unit 1600 satisfy a condition for processing in a predetermined order, and the condition relates to whether at least one of a width and height of the first coding unit 1600 is divided in half along a boundary of the second coding units 1610a, 1610b, 1610c, 1620a, 1620b, and 1620c. Referring to FIG. 16, since boundaries of the second coding units 1610a, 1610b, and 1610c determined by partitioning the square first coding unit 1600 in a vertical direction do not divide the width of the first coding unit 1600 in half, it may be determined that the first coding unit 1600 does not satisfy the condition for processing in the predetermined order. In addition, since boundaries of the second coding units 1620a, 1620b, and 1620c determined by partitioning the square first coding unit 1600 in a horizontal direction do not divide the width of the first coding unit 1600 in half, it may be determined that the first coding unit 1600 does not satisfy the condition for processing in the predetermined order. When the condition is not satisfied as described above, the image decoding apparatus 100 may decide disconnection of a scan order, and may determine that the first coding unit 1600 is partitioned into an odd number of coding units, based on the result of decision. According to an embodiment, when a coding unit is partitioned into an odd number of coding units, the image decoding apparatus 100 may put a predetermined restriction on a coding unit at a predetermined location from among the partitioned coding units. The restriction or the predetermined location has been described above in relation to various embodiments, and thus detailed descriptions thereof will not be provided herein.

According to an embodiment, the image decoding apparatus 100 may determine various-shaped coding units by partitioning a first coding unit.

Referring to FIG. 16, the image decoding apparatus 100 may partition the square first coding unit 1600 or a non-square first coding unit 1630 or 1650 into various-shaped coding units.

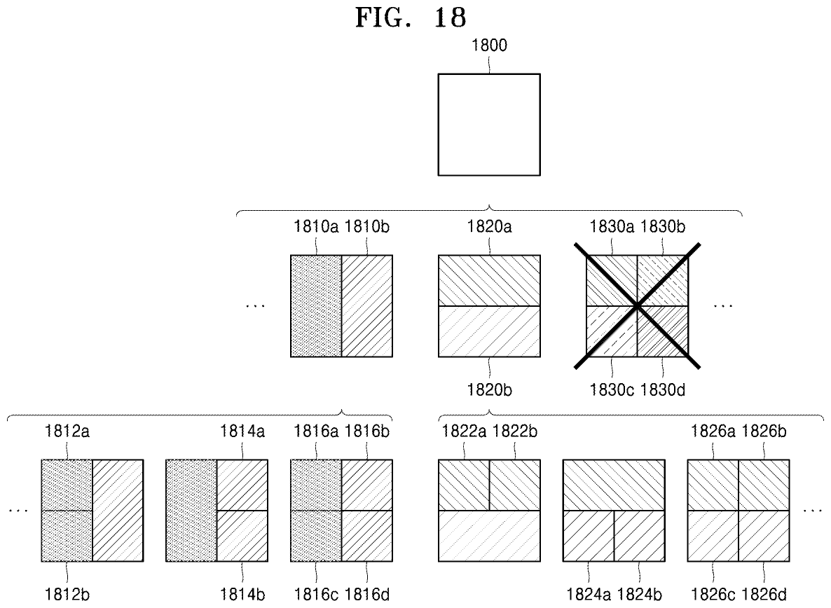

FIG. 17 illustrates that a shape into which a second coding unit is splittable by the image decoding apparatus 100 is restricted when the second coding unit having a non-square shape, which is determined by partitioning a first coding unit 1700, satisfies a predetermined condition, according to an embodiment.

According to an embodiment, the image decoding apparatus 100 may determine to partition the square first coding unit 1700 into non-square second coding units 1710a, 1710b, 1720a, and 1720b, based on at least one of block shape information and partition shape information, which is obtained by the receiver 210. The second coding units 1710a, 1710b, 1720a, and 1720b may be independently partitioned. As such, the image decoding apparatus 100 may determine to or not to partition the first coding unit 1700 into a plurality of coding units, based on at least one of the block shape information and the partition shape information of each of the second coding units 1710a, 1710b, 1720a, and 1720b. According to an embodiment, the image decoding apparatus 100 may determine third coding units 1712a and 1712b by partitioning the non-square left second coding unit 1710a, which is determined by partitioning the first coding unit 1700 in a vertical direction, in a horizontal direction. However, when the left second coding unit 1710a is partitioned in a horizontal direction, the image decoding apparatus 100 may restrict the right second coding unit 1710b not to be partitioned in a horizontal direction in which the left second coding unit 1710a is partitioned. When third coding units 1714a and 1714b are determined by also partitioning the right second coding unit 1710b in a horizontal direction, since the left and right second coding units 1710a and 1710b are independently partitioned in a horizontal direction, the third coding units 1712a, 1712b, 1714a, and 1714b may be determined. However, this case serves equally as a case in which the image decoding apparatus 100 partitions the first coding unit 1700 into four square second coding units 1730a, 1730b, 1730c, and 1730d, based on at least one of the block shape information and the partition shape information, and may be inefficient in terms of image decoding.

According to an embodiment, the image decoding apparatus 100 may determine third coding units 1722a, 1722b, 1724a, and 1724b by partitioning the non-square second coding unit 1720a or 1720b, which is determined by partitioning a first coding unit 11300 in a horizontal direction, in a vertical direction. However, when a second coding unit (e.g., the upper second coding unit 1720a) is partitioned in a vertical direction, due to the above-described reason, the image decoding apparatus 100 may restrict the other second coding unit (e.g., the lower second coding unit 1720b) not to be partitioned in a vertical direction in which the upper second coding unit 1720a is partitioned.

FIG. 18 illustrates an operation, performed by the image decoding apparatus 100, of partitioning a square coding unit when partition shape information indicates not to partition the square coding unit into four square coding units, according to an embodiment.

According to an embodiment, the image decoding apparatus 100 may determine second coding units 1810a, 1810b, 1820a, 1820b, etc. by partitioning a first coding unit 1800, based on at least one of block shape information and partition shape information. The partition shape information may include information about various methods of partitioning a coding unit but, the information about various partitioning methods may not include information for partitioning a coding unit into four square coding units. According to this partition shape information, the image decoding apparatus 100 may not partition the first square coding unit 1800 into four square second coding units 1830a, 1830b, 1830c, and 1830d. The image decoding apparatus 100 may determine the non-square second coding units 1810a, 1810b, 1820a, 1820b, etc., based on the partition shape information.

According to an embodiment, the image decoding apparatus 100 may independently partition the non-square second coding units 1810a, 1810b, 1820a, 1820b, etc. Each of the second coding units 1810a, 1810b, 1820a, 1820b, etc. may be recursively partitioned in a predetermined order, and this may correspond to a partitioning method of the first coding unit 1800, based on at least one of the block shape information and the partition shape information.

For example, the image decoding apparatus 100 may determine square third coding units 1812a and 1812b by partitioning the left second coding unit 1810a in a horizontal direction, and determine square third coding units 1814a and 1814b by partitioning the right second coding unit 1810b in a horizontal direction. Furthermore, the image decoding apparatus 100 may determine square third coding units 1816a to 1816d by partitioning both of the left and right second coding units 1810a and 1810b in a horizontal direction. In this case, coding units having the same shape as the four square second coding units 1830a, 1830b, 1830c, and 1830d partitioned from the first coding unit 1800 may be determined.

As another example, the image decoding apparatus 100 may determine square third coding units 1822a and 1822b by partitioning the upper second coding unit 1820a in a vertical direction, and may determine square third coding units 1824a and 1824b by partitioning the lower second coding unit 1820b in a vertical direction. Furthermore, the image decoding apparatus 100 may determine square third coding units 1822a, 1822b, 1824a, and 1824b by partitioning both of the upper and lower second coding units 1820a and 1820b in a vertical direction. In this case, coding units having the same shape as the four square second coding units 1830a, 1830b, 1830c, and 1830d partitioned from the first coding unit 1800 may be determined.

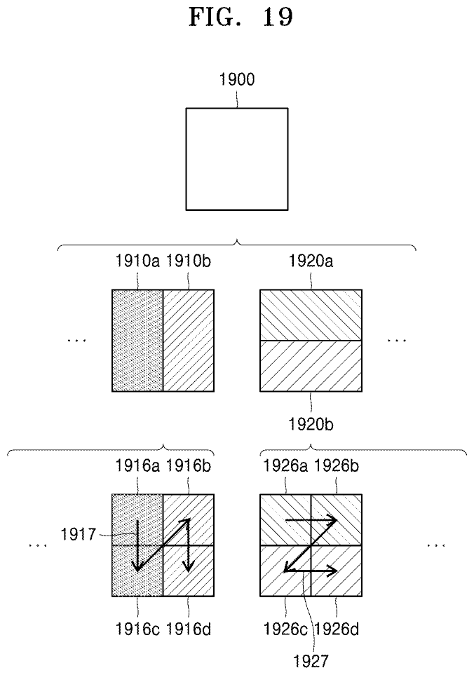

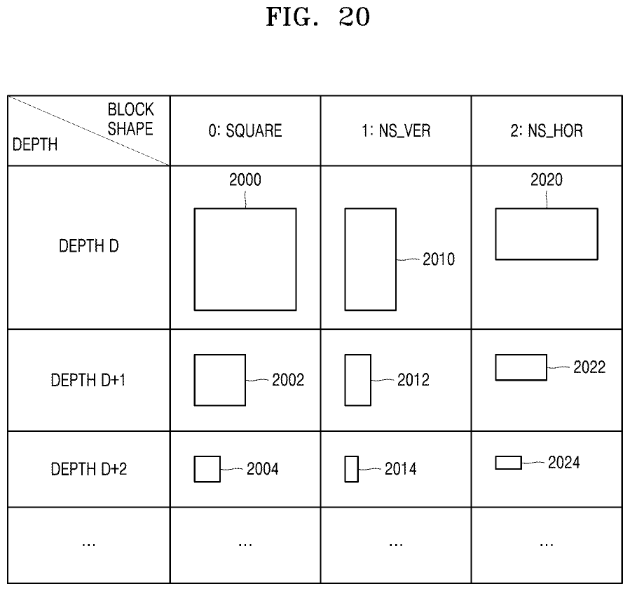

FIG. 19 illustrates that a processing order of a plurality of coding units is variable depending on an operation of partitioning a coding unit, according to an embodiment.

According to an embodiment, the image decoding apparatus 100 may partition a first coding unit 1900, based on block shape information and partition shape information. When the block shape information indicates a square shape and the partition shape information indicates to partition the first coding unit 1900 in at least one of horizontal and vertical directions, the image decoding apparatus 100 may determine second coding units 1910a, 1910b, 1920a, 1920b, 1930a, 1930b, 1930c, and 1930d by partitioning the first coding unit 1900. Referring to FIG. 19, the non-square second coding units 1910a, 1910b, 1920a, and 1920b determined by partitioning the first coding unit 1900 in only a horizontal direction or vertical direction may be independently partitioned based on the block shape information and the partition shape information of each coding unit. For example, the image decoding apparatus 100 may determine third coding units 1916a, 1916b, 1916c, and 1916d by partitioning the second coding units 1910a and 1910b, which are generated by partitioning the first coding unit 1900 in a vertical direction, in a horizontal direction, and determine third coding units 1926a, 1926b, 1926c, and 1926d by partitioning the second coding units 1920a and 1920b, which are generated by partitioning the first coding unit 1900 in a horizontal direction, in a horizontal direction. An operation of partitioning the second coding units 1910a, 1910b, 1920a, and 1920b has been described above in relation to FIG. 17, and thus detailed descriptions thereof will not be provided herein.

According to an embodiment, the image decoding apparatus 100 may process coding units in a predetermined order. An operation of processing coding units in a predetermined order has been described above in relation to FIG. 14, and thus detailed descriptions thereof will not be provided herein. Referring to FIG. 19, the image decoding apparatus 100 may determine the four square third coding units 1916a, 1916b, 1916c, 1916d, 1926a, 1926b, 1926c, and 1926d by partitioning the square first coding unit 1900. According to an embodiment, the image decoding apparatus 100 may determine a processing order of the third coding units 1916a, 1916b, 1916c, 1916d, 1926a, 1926b, 1926c, and 1926d based on a partitioning method of the first coding unit 1900.

According to an embodiment, the image decoding apparatus 100 may determine the third coding units 1916a, 1916b, 1916c, and 1916d by partitioning the second coding units 1910a and 1910b generated by partitioning the first coding unit 1900 in a vertical direction, in a horizontal direction, and may process the third coding units 1916a, 1916b, 1916c, and 1916d in a processing order 1917 for initially processing the third coding units 1916a and 1916b, which are included in the left second coding unit 1910a, in a vertical direction and then processing the third coding unit 1916c and 1916d, which are included in the right second coding unit 1910b, in a vertical direction.

According to an embodiment, the image decoding apparatus 100 may determine the third coding units 1926a, 1926b, 1926c, and 1926d by partitioning the second coding units 1920a and 1920b generated by partitioning the first coding unit 1900 in a horizontal direction, in a vertical direction, and process the third coding units 1926a, 1926b, 1926c, and 1926d in a processing order 1927 for initially processing the third coding units 1926a and 1926b, which are included in the upper second coding unit 1920a, in a horizontal direction and then processing the third coding unit 1926c and 1926d, which are included in the lower second coding unit 1920b, in a horizontal direction.

Referring to FIG. 19, the square third coding units 1916a, 1916b, 1916c, 1916d, 1926a, 1926b, 1926c, and 1926d may be determined by partitioning the second coding units 1910a, 1910b, 1920a, and 1920b. Although the second coding units 1910a and 1910b are determined by partitioning the first coding unit 1900 in a vertical direction differently from the second coding units 1920a and 1920b which are determined by partitioning the first coding unit 1900 in a horizontal direction, the third coding units 1916a, 1916b, 1916c, 1916d, 1926a, 1926b, 1926c, and 1926d partitioned therefrom eventually show same-shaped coding units partitioned from the first coding unit 1900. As such, by recursively partitioning a coding unit in different manners based on at least one of the block shape information and the partition shape information, the image decoding apparatus 100 may process a plurality of coding units in different orders even when the coding units are eventually determined to the same shape.

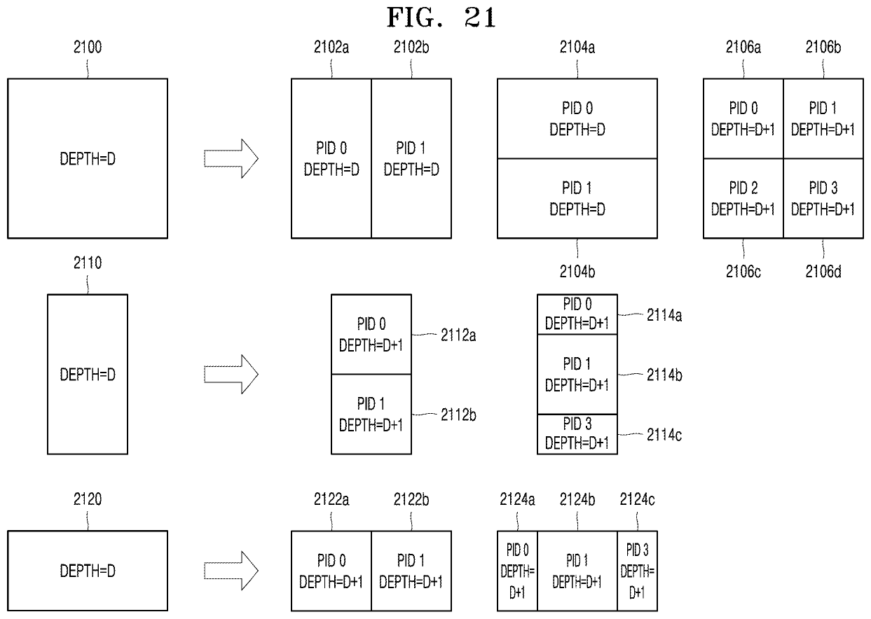

FIG. 20 illustrates an operation of determining a depth of a coding unit as the shape and size of the coding unit varies when a plurality of coding units are determined by recursively partitioning the coding unit, according to an embodiment.

According to an embodiment, the image decoding apparatus 100 may determine the depth of the coding unit based on a predetermined criterion. For example, the predetermined criterion may be the length of a long side of the coding unit. When the length of a long side of a coding unit before being partitioned is 2n times (n>0) the length of a long side of a partitioned current coding unit, the image decoding apparatus 100 may determine that a depth of the current coding unit is increased from a depth of the coding unit before being partitioned, by n. In the following description, a coding unit having an increased depth is expressed as a coding unit of a deeper depth.

Referring to FIG. 20, according to an embodiment, the image decoding apparatus 100 may determine a second coding unit 2002 and a third coding unit 2004 of deeper depths by partitioning a square first coding unit 2000 based on block shape information indicating a square shape (for example, the block shape information may be expressed as ‘0: SQUARE’). Assuming that the size of the square first coding unit 2000 is 2N×2N, the second coding unit 2002 determined by reducing a width and height of the first coding unit 2000 to ½¹ may have a size of N×N. Furthermore, the third coding unit 2004 determined by reducing a width and height of the second coding unit 2002 to ½ may have a size of N/2×N/2. In this case, a width and height of the third coding unit 2004 are ½² times those of the first coding unit 2000. When a depth of the first coding unit 2000 is D, a depth of the second coding unit 2002, the width and height of which are ½¹ times those of the first coding unit 2000, may be D+1, and a depth of the third coding unit 2004, the width and height of which are ½² times those of the first coding unit 2000, may be D+2.

According to an embodiment, the image decoding apparatus 100 may determine a second coding unit 2012 or 2022 and a third coding unit 2014 or 2024 of deeper depths by partitioning a non-square first coding unit 2010 or 2020 based on block shape information indicating a non-square shape (for example, the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit 2002, 2012, or 2022 by dividing at least one of a width and height of the first coding unit 2010 having a size of N×2N. That is, the image decoding apparatus 100 may determine the second coding unit 2002 having a size of N×N or the second coding unit 2022 having a size of N×N/2 by partitioning the first coding unit 2010 in a horizontal direction, or determine the second coding unit 2012 having a size of N/2×N by partitioning the first coding unit 2010 in horizontal and vertical directions.

According to an embodiment, the image decoding apparatus 100 may determine the second coding unit 2002, 2012, or 2022 by dividing at least one of a width and height of the first coding unit 2020 having a size of 2N×N. That is, the image decoding apparatus 100 may determine the second coding unit 2002 having a size of N×N or the second coding unit 2012 having a size of N/2×N by partitioning the first coding unit 2020 in a vertical direction, or determine the second coding unit 2022 having a size of N×N/2 by partitioning the first coding unit 2020 in horizontal and vertical directions.

According to an embodiment, the image decoding apparatus 100 may determine a third coding unit 2004, 2014, or 2024 by dividing at least one of a width and height of the second coding unit 2002 having a size of N×N. That is, the image decoding apparatus 100 may determine the third coding unit 2004 having a size of N/2×N/2, the third coding unit 2014 having a size of N/2²×N/2, or the third coding unit 2024 having a size of N/2×N/2² by partitioning the second coding unit 2002 in vertical and horizontal directions.

According to an embodiment, the image decoding apparatus 100 may determine the third coding unit 2004, 2014, or 2024 by dividing at least one of a width and height of the second coding unit 2012 having a size of N/2×N. That is, the image decoding apparatus 100 may determine the third coding unit 2004 having a size of N/2×N/2 or the third coding unit 2024 having a size of N/2×N/2² by partitioning the second coding unit 2012 in a horizontal direction, or determine the third coding unit 2014 having a size of N/2²×N/2 by partitioning the second coding unit 2012 in vertical and horizontal directions.

According to an embodiment, the image decoding apparatus 100 may determine the third coding unit 2004, 2014, or 2024 by dividing at least one of a width and height of the second coding unit 2014 having a size of N×N/2. That is, the image decoding apparatus 100 may determine the third coding unit 2004 having a size of N/2×N/2 or the third coding unit 2014 having a size of N/2²×N/2 by partitioning the second coding unit 2012 in a vertical direction, or determine the third coding unit 2024 having a size of N/2×N/2² by partitioning the second coding unit 2022 in vertical and horizontal directions.

According to an embodiment, the image decoding apparatus 100 may partition the square coding unit 2000, 2002, or 2004 in a horizontal or vertical direction. For example, the image decoding apparatus 100 may determine the first coding unit 2010 having a size of N×2N by partitioning the first coding unit 2000 having a size of 2N×2N in a vertical direction, or determine the first coding unit 2020 having a size of 2N×N by partitioning the first coding unit 2000 in a horizontal direction. According to an embodiment, when a depth is determined based on the length of the longest side of a coding unit, a depth of a coding unit determined by partitioning the first coding unit 2000, 2002 or 2004 having a size of 2N×2N in a horizontal or vertical direction may be the same as the depth of the first coding unit 2000, 2002 or 2004.

According to an embodiment, a width and height of the third coding unit 2014 or 2024 may be ½² times those of the first coding unit 2010 or 2020. When a depth of the first coding unit 2010 or 2020 is D, a depth of the second coding unit 2012 or 2014, the width and height of which are ½ times those of the first coding unit 2010 or 2020, may be D+1, and a depth of the third coding unit 2014 or 2024, the width and height of which are ½² times those of the first coding unit 2010 or 2020, may be D+2.

FIG. 21 illustrates depths of coding units and part indices (PIDs) for distinguishing the coding units, which may be determined based on the shapes and sizes of the coding units, according to an embodiment.

According to an embodiment, the image decoding apparatus 100 may determine various-shaped second coding units by partitioning a square first coding unit 2100. Referring to FIG. 21, the image decoding apparatus 100 may determine second coding units 2102a, 2102b, 2104a, 2104b, 2106a, 2106b, 2106c, and 2106d by partitioning the first coding unit 2100 in at least one of vertical and horizontal directions based on partition shape information. That is, the image decoding apparatus 100 may determine the second coding units 2102a, 2102b, 2104a, 2104b, 2106a, 2106b, 2106c, and 2106d based on the partition shape information of the first coding unit 2100.

According to an embodiment, a depth of the second coding units 2102a, 2102b, 2104a, 2104b, 2106a, 2106b, 2106c, and 2106d, which are determined based on the partition shape information of the square first coding unit 2100, may be determined based on the length of a long side thereof. For example, since the length of a side of the square first coding unit 2100 equals the length of a long side of the non-square second coding units 2102a, 2102b, 2104a, and 2104b, the first coding unit 2100 and the non-square second coding units 2102a, 2102b, 2104a, and 2104b may have the same depth, e.g., D. However, when the image decoding apparatus 100 partitions the first coding unit 2100 into the four square second coding units 2106a, 2106b, 2106c, and 2106d based on the partition shape information, since the length of a side of the square second coding units 2106a, 2106b, 2106c, and 2106d is ½ times the length of a side of the first coding unit 2100, a depth of the second coding units 2106a, 2106b, 2106c, and 2106d may be D+1 which is deeper than the depth D of the first coding unit 2100 by 1.

According to an embodiment, the image decoding apparatus 100 may determine a plurality of second coding units 2112a, 2112b, 2114a, 2114b, and 2114c by partitioning a first coding unit 2110, a height of which is longer than a width, in a horizontal direction based on the partition shape information. According to an embodiment, the image decoding apparatus 100 may determine a plurality of second coding units 2122a, 2122b, 2124a, 2124b, and 2124c by partitioning a first coding unit 2120, a width of which is longer than a height, in a vertical direction based on the partition shape information.

According to an embodiment, a depth of the second coding units 2112a, 2112b, 2114a, 2114b, 2116a, 2116b, 2116c, and 2116d, which are determined based on the partition shape information of the non-square first coding unit 2110 or 2120, may be determined based on the length of a long side thereof. For example, since the length of a side of the square second coding units 2112a and 2112b is ½ times the length of a long side of the first coding unit 2110 having a non-square shape, a height of which is longer than a width, a depth of the square second coding units 2102a, 2102b, 2104a, and 2104b is D+1 which is deeper than the depth D of the non-square first coding unit 2110 by 1.

Furthermore, the image decoding apparatus 100 may partition the non-square first coding unit 2110 into an odd number of second coding units 2114a, 2114b, and 2114c based on the partition shape information. The odd number of second coding units 2114a, 2114b, and 2114c may include the non-square second coding units 2114a and 2114c and the square second coding unit 2114b. In this case, since the length of a long side of the non-square second coding units 2114a and 2114c and the length of a side of the square second coding unit 2114b are ½ times the length of a long side of the first coding unit 2110, a depth of the second coding units 2114a, 2114b, and 2114c may be D+1 which is deeper than the depth D of the non-square first coding unit 2110 by 1. The image decoding apparatus 100 may determine depths of coding units partitioned from the first coding unit 2120 having a non-square shape, a width of which is longer than a height, by using the above-described method of determining depths of coding units partitioned from the first coding unit 2110.

According to an embodiment, the image decoding apparatus 100 may determine PIDs for identifying partitioned coding units, based on a size ratio between the coding units when an odd number of partitioned coding units do not have equal sizes. Referring to FIG. 21, a coding unit 2114b of a center location among an odd number of partitioned coding units 2114a, 2114b, and 2114c may have a width equal to that of the other coding units 2114a and 2114c and a height which is two times that of the other coding units 2114a and 2114c. That is, in this case, the coding unit 2114b at the center location may include two of the other coding unit 2114a or 2114c. Therefore, assuming that a PID of the coding unit 2114b at the center location is 1 based on a scan order, a PID of the coding unit 2114c located next to the coding unit 2114b may be increased by 2 and thus may be 3. That is, discontinuity in PID values may be present. According to an embodiment, the image decoding apparatus 100 may determine whether an odd number of partitioned coding units do not have equal sizes, based on whether discontinuity is present in PIDs for identifying the partitioned coding units.

According to an embodiment, the image decoding apparatus 100 may determine whether to use a specific partitioning method, based on PID values for identifying a plurality of coding units determined by partitioning a current coding unit. Referring to FIG. 21, the image decoding apparatus 100 may determine an even number of coding units 2112a and 2112b or an odd number of coding units 2114a, 2114b, and 2114c by partitioning the first coding unit 2110 having a rectangular shape, a height of which is longer than a width. The image decoding apparatus 100 may use PIDs to identify a plurality of coding units. According to an embodiment, the PID may be obtained from a sample of a predetermined location of each coding unit (e.g., a top left sample).

According to an embodiment, the image decoding apparatus 100 may determine a coding unit at a predetermined location from among the partitioned coding units, by using the PIDs for distinguishing the coding units. According to an embodiment, when the partition shape information of the first coding unit 2110 having a rectangular shape, a height of which is longer than a width, indicates to partition a coding unit into three coding units, the image decoding apparatus 100 may partition the first coding unit 2110 into three coding units 2114a, 2114b, and 2114c. The image decoding apparatus 100 may assign a PID to each of the three coding units 2114a, 2114b, and 2114c. The image decoding apparatus 100 may compare PIDs of an odd number of partitioned coding units to determine a coding unit at a center location from among the coding units. The image decoding apparatus 100 may determine the coding unit 2114b having a PID corresponding to a middle value among the PIDs of the coding units, as the coding unit at the center location from among the coding units determined by partitioning the first coding unit 2110. According to an embodiment, the image decoding apparatus 100 may determine PIDs for distinguishing partitioned coding units, based on a size ratio between the coding units when the partitioned coding units do not have equal sizes. Referring to FIG. 21, the coding unit 2114b generated by partitioning the first coding unit 2110 may have a width equal to that of the other coding units 2114a and 2114c and a height which is two times that of the other coding units 2114a and 2114c. In this case, assuming that the PID of the coding unit 2114b at the center location is 1, the PID of the coding unit 2114c located next to the coding unit 2114b may be increased by 2 and thus may be 3. When the PID is not uniformly increased as described above, the image decoding apparatus 100 may determine that a coding unit is partitioned into a plurality of coding units including a coding unit having a size different from that of the other coding units. According to an embodiment, when the partition shape information indicates to partition a coding unit into an odd number of coding units, the image decoding apparatus 100 may partition a current coding unit in such a manner that a coding unit of a predetermined location among an odd number of coding units (e.g., a coding unit of a centre location) has a size different from that of the other coding units. In this case, the image decoding apparatus 100, may determine the coding unit of the centre location, which has a different size, by using PIDs of the coding units. However, the PIDs and the size or location of the coding unit of the predetermined location are not limited to the above-described examples, and various PIDs and various locations and sizes of coding units may be used.

According to an embodiment, the image decoding apparatus 100 may use a predetermined data unit where a coding unit starts to be recursively partitioned.

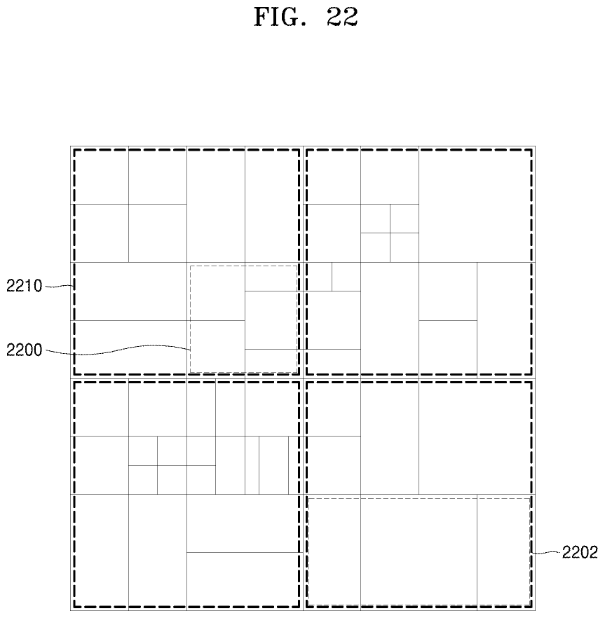

FIG. 22 illustrates that a plurality of coding units are determined based on a plurality of predetermined data units included in a picture, according to an embodiment.

According to an embodiment, a predetermined data unit may be defined as a data unit where a coding unit starts to be recursively partitioned by using at least one of block shape information and partition shape information. That is, the predetermined data unit may correspond to a coding unit of an uppermost depth, which is used to determine a plurality of coding units partitioned from a current picture. In the following description, for convenience of explanation, the predetermined data unit is referred to as a reference data unit.

According to an embodiment, the reference data unit may have a predetermined size and shape. According to an embodiment, a reference coding unit may include M×N samples. Herein, M and N may be equal values, and may be integers expressed as multipliers of 2. That is, the reference data unit may have a square or non-square shape, and may be an integer number of coding units.

According to an embodiment, the image decoding apparatus 100 may partition the current picture into a plurality of reference data units. According to an embodiment, the image decoding apparatus 100 may partition the plurality of reference data units, which are partitioned from the current picture, by using partitioning information of each reference data unit. The operation of partitioning the reference data unit may correspond to a partitioning operation using a quadtree structure.

According to an embodiment, the image decoding apparatus 100 may previously determine the minimum size allowed for the reference data units included in the current picture. As such, the image decoding apparatus 100 may determine various reference data units having sizes equal to or greater than the minimum size, and determine one or more coding units by using the block shape information and the partition shape information with reference to the determined reference data unit.

Referring to FIG. 22, the image decoding apparatus 100 may use a square reference coding unit 2200 or a non-square reference coding unit 2202. According to an embodiment, the shape and size of reference coding units may be determined based on various data units capable of including one or more reference coding units (e.g., sequences, pictures, slices, slice segments, and largest coding units).

According to an embodiment, the receiver 210 of the image decoding apparatus 100 may obtain, from a bitstream, at least one of reference coding unit shape information and reference coding unit size information with respect to each of the various data units. An operation of partitioning the square reference coding unit 2200 into one or more coding units has been described above in relation to the operation of partitioning the current coding unit 300 of FIG. 10, and an operation of partitioning the non-square reference coding unit 2200 into one or more coding units has been described above in relation to the operation of partitioning the current coding unit 1100 or 1150 of FIG. 11. Thus, detailed descriptions thereof will not be provided herein.

According to an embodiment, the image decoding apparatus 100 may use a PID for identifying the size and shape of reference coding units, to determine the size and shape of reference coding units according to some data units previously determined based on a predetermined condition. That is, the receiver 210 may obtain, from the bitstream, only the PID for identifying the size and shape of reference coding units with respect to each slice, slice segment, or largest coding unit which is a data unit satisfying a predetermined condition (e.g., a data unit having a size equal to or smaller than a slice) among the various data units (e.g., sequences, pictures, slices, slice segments, and largest coding units). The image decoding apparatus 100 may determine the size and shape of reference data units with respect to each data unit, which satisfies the predetermined condition, by using the PID. When the reference coding unit shape information and the reference coding unit size information are obtained and used from the bitstream according to each data unit having a relatively small size, since efficiency of using the bitstream may not be good, only the PID may be obtained and used instead of directly obtaining the reference coding unit shape information and the reference coding unit size information. In this case, at least one of the size and shape of reference coding units corresponding to the PID for identifying the size and shape of reference coding units may be previously determined. That is, the image decoding apparatus 100 may determine at least one of the size and shape of reference coding units included in a data unit serving as a unit for obtaining the PID, by selecting the previously determined at least one of the size and shape of reference coding units based on the PID.

According to an embodiment, the image decoding apparatus 100 may use one or more reference coding units included in a largest coding unit. That is, a largest coding unit partitioned from a picture may include one or more reference coding units, and coding units may be determined by recursively partitioning each reference coding unit. According to an embodiment, at least one of a width and height of the largest coding unit may be integer times at least one of the width and height of the reference coding units. According to an embodiment, the size of reference coding units may be obtained by partitioning the largest coding unit n times based on a quadtree structure. That is, the image decoding apparatus 100 may determine the reference coding units by partitioning the largest coding unit n times based on a quadtree structure, and partition the reference coding unit based on at least one of the block shape information and the partition shape information according to various embodiments.

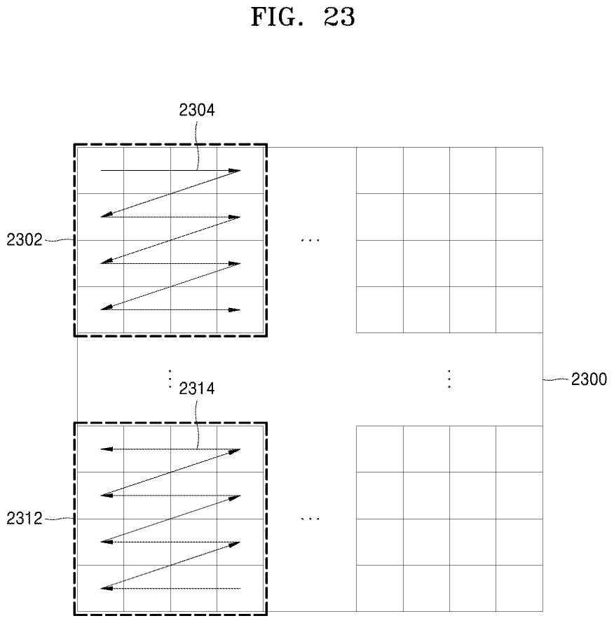

FIG. 23 illustrates a processing block serving as a unit for determining a determination order of reference coding units included in a picture 2300, according to an embodiment.

According to an embodiment, the image decoding apparatus 100 may determine one or more processing blocks partitioned from a picture. The processing block is a data unit including one or more reference coding units partitioned from a picture, and the one or more reference coding units included in the processing block may be determined in a specific order. That is, a determination order of one or more reference coding units determined in each processing block may correspond to one of various types of orders for determining reference coding units, and may vary depending on the processing block. The determination order of reference coding units, which is determined with respect to each processing block, may be one of various orders, e.g., raster scan order, Z-scan, N-scan, up-right diagonal scan, horizontal scan, and vertical scan, but is not limited to the above-mentioned scan orders.

According to an embodiment, the image decoding apparatus 100 may obtain processing block size information and determine the size of one or more processing blocks included in the picture. The image decoding apparatus 100 may obtain the processing block size information from a bitstream and determine the size of one or more processing blocks included in the picture. The size of processing blocks may be a predetermined size of data units, which is indicated by the processing block size information.

According to an embodiment, the receiver 210 of the image decoding apparatus 100 may obtain the processing block size information from the bitstream according to each specific data unit. For example, the processing block size information may be obtained from the bitstream in a data unit such as image, sequence, picture, slice, or slice segment. That is, the receiver 210 may obtain the processing block size information from the bitstream according to each of the various data units, and the image decoding apparatus 100 may determine the size of one or more processing blocks, which are partitioned from the picture, by using the obtained processing block size information. The size of processing blocks may be integer times that of the reference coding units.

According to an embodiment, the image decoding apparatus 100 may determine the size of processing blocks 2302 and 2312 included in the picture 2300. For example, the image decoding apparatus 100 may determine the size of processing blocks based on the processing block size information obtained from the bitstream. Referring to FIG. 23, according to an embodiment, the image decoding apparatus 100 may determine a width of the processing blocks 2302 and 2312 to be four times the width of the reference coding units, and may determine a height of the processing blocks 2302 and 2312 to be four times the height of the reference coding units. The image decoding apparatus 100 may determine a determination order of one or more reference coding units in one or more processing blocks.

According to an embodiment, the image decoding apparatus 100 may determine the processing blocks 2302 and 2312, which are included in the picture 2300, based on the size of processing blocks, and determine a determination order of one or more reference coding units in the processing blocks 2302 and 2312. According to an embodiment, determination of reference coding units may include determination of the size of reference coding units.

According to an embodiment, the image decoding apparatus 100 may obtain, from the bitstream, determination order information of one or more reference coding units included in one or more processing blocks, and determine a determination order to one or more reference coding units based on the obtained determination order information. The determination order information may be defined as an order or direction for determining the reference coding units in the processing block. That is, the determination order of reference coding units may be independently determined with respect to each processing block.

According to an embodiment, the image decoding apparatus 100 may obtain the determination order information of reference coding units from the bitstream according to each specific data unit. For example, the receiver 210 may obtain the determination order information of reference coding units from the bitstream according to each data unit such as image, sequence, picture, slice, slice segment, or processing block. Since the determination order information of reference coding units indicates an order for determining reference coding units in a processing block, the determination order information may be obtained with respect to each specific data unit including an integer number of processing blocks.

According to an embodiment, the image decoding apparatus 100 may determine one or more reference coding units based on the determined determination order.

According to an embodiment, the receiver 210 may obtain the determination order information of reference coding units from the bitstream as information related to the processing blocks 2302 and 2312, and the image decoding apparatus 100 may determine a determination order of one or more reference coding units included in the processing blocks 2302 and 2312 and determine one or more reference coding units, which are included in the picture 2300, based on the determination order. Referring to FIG. 23, the image decoding apparatus 100 may determine determination orders 2304 and 2314 of one or more reference coding units in the processing blocks 2302 and 2312, respectively. For example, when the determination order information of reference coding units is obtained with respect to each processing block, different types of the determination order information of reference coding units may be obtained for the processing blocks 2302 and 2312. When the determination order 2304 of reference coding units in the processing block 2302 is a raster scan order, reference coding units included the processing block 2302 may be determined in a raster scan order. Unlike this, when the determination order 2314 of reference coding units in the other processing block 2312 is an inverse raster scan order, reference coding units included in the processing block 2312 may be determined in an inverse raster scan order.

According to an embodiment, the image decoding apparatus 100 may decode the determined one or more reference coding units. The image decoding apparatus 100 may decode the picture based on the reference coding units determined as described above. A method of decoding the reference coding units may include various image decoding methods.

According to an embodiment, the image decoding apparatus 100 may obtain block shape information indicating the shape of a current coding unit or partition shape information indicating a partitioning method of the current coding unit, from the bitstream, and use the obtained information. The block shape information or the partition shape information may be included in the bitstream related to various data units. For example, the image decoding apparatus 100 may use the block shape information or the partition shape information included in a sequence parameter set, a picture parameter set, a video parameter set, a slice header, or a slice segment header. Furthermore, the image decoding apparatus 100 may obtain syntax corresponding to the block shape information or the partition shape information from the bitstream according to each largest coding unit, reference coding unit, or processing block, and use the obtained syntax.

While the present disclosure has been particularly shown and described with reference to embodiments thereof, it will be understood by one of ordinary skill in the art that various changes in form and details may be made therein without departing from the scope of the disclosure as defined by the following claims. The embodiments should be considered in a descriptive sense only and not for purposes of limitation. Therefore, the scope of the disclosure is defined not by the detailed description of the disclosure but by the following claims, and all differences within the scope will be construed as being included in the present disclosure.

Meanwhile, the afore-described embodiments of the present disclosure can be written as computer programs and can be implemented in general-use digital computers that execute the programs by using a computer-readable recording medium. Examples of the computer-readable recording medium include magnetic storage media (e.g., ROM, floppy disks, hard disks, etc.), optical recording media (e.g., CD-ROMs, or DVDs), etc.

1. An image decoding method comprising:
determining, based on image data obtained from a bitstream, a plurality of coding units comprised in a current slice that is one of a plurality of slices comprised in an image;
determining a prediction method performed on a current coding unit that is one of the plurality of coding units;
determining a quantization parameter of the current coding unit, based on whether the prediction method performed on the current coding unit is inter prediction or intra prediction; and
decoding the image by using the determined quantization parameter.

2. The image decoding method of claim 1, wherein the determining of the quantization parameter of the current coding unit comprises:
determining whether a type of the current slice comprising the current coding unit is an intra slice type or an inter slice type; and
when the type of the current slice is an inter slice, determining the quantization parameter of the current coding unit, based on whether the prediction method performed on the current coding unit is the inter prediction or the intra prediction.

3. The image decoding method of claim 1, wherein the determining of the quantization parameter of the current coding unit comprises:
obtaining at least one offset information from the bitstream; and
determining the quantization parameter of the current coding unit, based on the at least one offset information and a quantization parameter of at least one of an intra coding unit and an inter coding unit, wherein the intra coding unit is a coding unit on which the intra prediction is to be performed and the inter coding unit is a coding unit on which the inter prediction is to be performed.

4. The image decoding method of claim 3, wherein the determining of the quantization parameter of the current coding unit comprises determining the quantization parameter of the intra coding unit, based on a quantization parameter of the current slice and a first offset comprised in the at least one offset information, wherein the quantization parameter of the intra coding unit is greater than the quantization parameter of the inter coding unit.

5. The image decoding method of claim 4, wherein the quantization parameter of the inter coding unit is equal to the quantization parameter of the current slice.

6. The image decoding method of claim 3, wherein the determining of the quantization parameter of the current coding unit comprises:
determining the quantization parameter of the intra coding unit, based on a quantization parameter of the current slice and a first offset comprised in the at least one offset information; and
determining the quantization parameter of the inter coding unit, based on the quantization parameter of the current slice and a second offset comprised in the at least one offset information.

7. The image decoding method of claim 3, wherein the determining of the quantization parameter of the current coding unit comprises:
determining the quantization parameter of the intra coding unit by adding a third offset to a quantization parameter of the current slice, the third offset being comprised in the at least one offset information; and
determining the quantization parameter of the inter coding unit by subtracting the third offset from the quantization parameter of the current slice, wherein the third offset has a value greater than 0.

8. The image decoding method of claim 3, wherein the obtaining of the at least one offset information comprises obtaining the at least one offset information from the bitstream with respect to at least one of a sequence parameter set (SPS), a picture parameter set (PPS), a slice header, and a largest coding unit.

9. The image decoding method of claim 1, wherein the determining of the quantization parameter of the current coding unit comprises:
determining a quantization parameter of the current slice;
determining a base quantization parameter of the current coding unit, based on the quantization parameter of the current slice and a difference quantization parameter obtained from the bitstream according to each of the plurality of coding units;
determining an offset of the current coding unit, based on whether the prediction method performed on the current coding unit is inter prediction or intra prediction; and
determining the quantization parameter of the current coding unit, based on the base quantization parameter and the offset.

10. The image decoding method of claim 1, wherein the determining of the quantization parameter of the current coding unit comprises, only when the current slice is determined to be a slice to be referred to in a process of performing inter prediction in the image, determining the quantization parameter of the current coding unit based on whether the prediction method performed on the current coding unit is inter prediction or intra prediction.

11. The image decoding method of claim 1, wherein the determining of the quantization parameter of the current coding unit comprises:
determining whether a size of the current coding unit is equal to or less than a preset size; and
when the size of the current coding unit is equal to or less than the preset size, determining the quantization parameter of the current coding unit based on whether the prediction method performed on the current coding unit is inter prediction or intra prediction.

12. The image decoding method of claim 11, wherein the determining of the quantization parameter of the current coding unit comprises, when the size of the current coding unit is greater than the preset size, determining the quantization parameter of the current coding unit based on a quantization parameter of the current slice and a difference quantization parameter of the current coding unit, the difference quantization parameter being obtained from the bitstream.

13. The image decoding method of claim 1, wherein the decoding of the image comprises:
determining a reconstructed image associated with the image, based on the determined quantization parameter;
performing deblocking filtering on the reconstructed image; and
determining a filtered reconstructed image, based on a result of the deblocking filtering.

14. An image decoding apparatus comprising:
an obtainer configured to obtain image data from a bitstream;
a decoder configured to determine, based on the image data, a plurality of coding units comprised in a current slice that is one of a plurality of slices comprised in an image, to determine a prediction method performed on a current coding unit that is one of the plurality of coding units, to determine a quantization parameter of the current coding unit, based on whether the prediction method performed on the current coding unit is inter prediction or intra prediction, and to decode the image by using the determined quantization parameter.

15. An image encoding method comprising:
determining a plurality of coding units comprised in a current slice that is one of a plurality of slices comprised in an image;
determining a prediction method performed on a current coding unit that is one of the plurality of coding units;
determining a quantization parameter of the current coding unit, based on whether the prediction method performed on the current coding unit is inter prediction or intra prediction; and
generating a bitstream comprising information about the image encoded by using the determined quantization parameter.
